(19) United States
(12) Patent Application Publication
(10) Pub. No.: US 2007/0083403 A1
(43) Pub. Date: Apr. 12, 2007

(54) Referral management method, apparatus and system

(75) Inventors: Gregory Arthur Baldwin, West Vancouver, BC (CA); Damian Nicholas Burianyk, Burnaby, BC (CA); Robbie James McKenzie, Burnaby, BC (CA)

Correspondence Address: GANZ LAW, P.C., P O BOX 2200, HILLSBORO, OR, 97123, US

(73) Assignee: CRYSTALLON SYSTEMS, INC., Burnaby, BC (CA)

(21) Appl. No.: 10/596,100

(22) PCT Filed: Dec. 20, 2004
(86) PCT No.: PCT/CA04/02167

§ 371 Date: May 30, 2006

Related U.S. Application Data
(60) Provisional application No. 60/556,379, filed on Mar. 26, 2004.

(51) Int. Cl. G06F 17/50

(52) U.S. Cl. 705/7

(57) ABSTRACT

A referral information communication and management method, apparatus and system, with related computer-readable media, signals, data-structures and program codes, involving, in response to signals received from respective client computers associated with a referrer and referee of a referral from the referrer to the referee: (1) storing information pertaining to the referral in a database as a collection of linked information units, the information units including a referrer identifier identifying the referrer as originator of the information and a referee identifier identifying the referee as intended recipient of the information, the collection representing the referral and being accessible by the respective client computers; (2) identifying collections of information units that satisfy a criterion, and displaying corresponding identifications at one of the client computers; (3) causing at least one information unit in a collection corresponding to a displayed identification, to be displayed at the client computer; and (4) causing at least one information unit in a collection corresponding to a displayed identification, to be modified.

### CROSS REFERENCES TO RELATED APPLICATIONS

This application claims priority from U.S. Provisional Application No. 60/556,379 filed Mar. 26, 2004, incorporated herein by reference.

### BACKGROUND OF THE INVENTION

1. Field of Invention

This invention relates to information communication and management, and more particularly, to systems, methods, apparatuses, user interfaces, computer-readable data structures, media and signals, for communicating and managing information associated with referrals between referring and referee parties.

2. Description of Related Art

In many fields, a first party with a client having a problem or need, may be unable to fully service the problem or need. To ensure that the client's problem is fully serviced, the first party may seek assistance from a second party better able to service the problem. Seeking assistance may involve the first party identifying a suitable second party having expertise in addressing the problem, and communicating all the necessary information to the second party, so that the second party may apply its expertise and judgment to address the problem of the first party's client. In addition, the first party may wish to refer the client to the second party for an appointment so that the second party may directly investigate and address the problem, and/or provide information back to the first party to enable the first party to better address the problem. This process, known as a “referral”, involves exchanging information regarding the client and the client's problem between the first (referring) party and the second (consulting) party, and may also involve the first (referring) party arranging an appointment between the client and the second (consulting) party. In this process, the first party is an originator or “referrer” of the referral, and the second party is a recipient or “referee” of the referral.

As will be appreciated, referral processes in many fields involve significant difficulties, for example, in locating a suitable referee for a referral, in tracking relevant information pertaining to the referral (including information about the problem or need at issue), in communicating or exchanging this information between all the relevant parties, and in arranging appointments and/or other follow-up between the referrer, referee and the referral subject (i.e., the client). Moreover, all of these aspects of a referral must be managed in a manner that is appropriate to the nature of the problem or need at issue. In addition, a detailed and accurate record of the progress and results of the referral may need to be accumulated, shared between various parties, and ultimately archived.

In the field of medicine, such referral-related difficulties are especially acute. A referral that is sent from a referring physician or medical doctor (M.D.) to a consulting physician or medical doctor (M.D.) in respect of a patient's medical condition, is typically manually arranged by medical office assistants (MOA's) associated with the physicians, who exchange telephone calls, paper-based forms and/or letters in order to arrange the referral between the physicians. In addition to being inefficient, such an approach to arranging referrals is highly vulnerable to error. It is not uncommon for inappropriate referrals to be sent to a consulting physician, who may eventually refuse the referral or re-refer the patient to a more appropriate consulting physician, thereby wasting both time and money, and possibly inconveniencing or endangering the patient. Even when an appropriate referral is made, the referral may be inadvertently lost or ignored by the consulting physician without any notice of this to the referring physician, who may (falsely) believe that the consulting physician is proceeding apace with the referral. In some cases, it may be discovered—too late—that a sent referral omits critical patient information necessary for the consulting physician to handle the referral (e.g., specific medical test results). It is well known that, in many respects, current approaches to managing medical referrals are notoriously slow, error-prone, and hence expensive.

Although the prior art has disclosed referral-support systems for electronically transmitting referral information relating to a referral from a referrer to a referee, a number of shortcomings are associated with existing solutions. Many of these systems rely on ordinary email messages to send the referral information to the referee. Unfortunately, systems depending on ordinary email messages may be relatively insecure and vulnerable to viruses and spam, for example. Furthermore, in an email-based referral system, a referrer no longer has access to a email once it has been sent, and therefore is unable to view or modify sent referral information. Of course, the referrer can save a local copy of the sent email in order to facilitate local viewing of sent referral information. However, saving a local copy of the email does not enable the referrer to modify or update any sent referral information ex post facto. Furthermore, if upon receiving the sent referral information the referee modifies or updates any of it, such changes or updates will not be reflected in the referrer's local copy of the sent referral information, since the referrer and referee do not share access to the same referral information. Thus, many email-based systems fail to facilitate systematic and ongoing sharing of referral information between a referrer and referee.

### SUMMARY OF THE INVENTION

The present invention addresses these and other problems relating to referral management, and may be advantageously applied in many fields including the field of medicine.

Generally, there is provided a referral management system having a secure client-server network architecture, comprising a server communicating with a plurality of client computers, to support referral-related communications from a plurality of referrers to a plurality of referees at respective client computers. A referral from a referrer to a referee is represented in a database by a collection of linked information units. Each collection is accessible by both its respective referrer and referee in accordance with a prescribed workflow. Advantageously, within limits imposed by the prescribed workflow, parties to a referral can view and modify the current content or status of the collection representing the referral, and thus, ongoing interactive referral-related communication between referrers and referees is integrally supported. Messaging features may also be supported.

Furthermore, the system described provides for the flexible filtering and/or sorting of electronic referrals and messages by a variety of criteria. Electronic referrals may be managed in response to various referral properties, such as referral status (e.g., unread/read, appointment made/pending, added to wait list, cancelled or complete), referral priority (e.g., routine and urgent), and modifications made to the referral (e.g., changes of appointment, changes of wait list status, cancellation and completion), for example. When the referrer or referee changes the properties of an electronic referral, the other party can use the aforesaid filtering features to identify that referral as having been updated.

Moreover, complementary functions for affecting referral properties may be provided to the referrer and referee, thereby effecting a variety of request/response mechanisms between the referrer and referee. For example, the referrer can modify the collection of information units representing the referral to indicate a waitlist request. The referee can then detect the waitlist request by filtering the database for collections that include a waitlist request, for example. The referee can then modify the collection to indicate that the waitlist request was accepted. Similarly, the referee can detect the acceptance of the waitlist request by filtering the database appropriately. Many other useful interactions are possible between the referrer and referee by use of this system.

Generally, significant system events and transactions pertaining to a referral are permanently recorded in association with the referral, and cause notifications to issue to one or more parties to the referral. For example, if one party creates a new referral, views a new referral, or modifies an existing referral, the other party to the referral may be notified of this event or transaction. Advantageously, detailed and reliable records of referrals are automatically generated by the system for medical and legal purposes, and parties to a referral are automatically apprised of referral progress at significant milestones.

Moreover, the system may include provisions to ensure that a referral includes the information necessary for the referee to handle the referral to reduce incomplete referrals, for example. Other provisions may optionally verify that a referral meets the acceptance criteria for a particular referee to whom the referral is being sent to reduce unwanted or inappropriate referrals, for example.

In accordance with one aspect of the invention, there is provided a method of managing referrals from a referrer to a referee. The method involves: in response to a first set of signals received from a referrer computer, storing, in a database, information pertaining to a referral from the referrer to the referee, the information being stored as a collection of linked information units, the information units including a referrer identifier identifying the referrer as originator of the information and a referee identifier identifying the referee as intended recipient of the information, the collection representing the referral and being accessible by the referrer computer and a referee computer; in response to a second set of signals received from one of the referrer and referee computers, identifying, in the database, collections of information units that satisfy a criterion, and displaying identifications, at the one of the referrer and referee computers, corresponding to respective collections of information units satisfying the criterion; in response to a third set of signals received from the one of the referrer and referee computers, causing at least one information unit in a collection corresponding to a displayed identification, to be displayed at the one of the referrer and referee computers; and in response to a fourth set of signals received from the one of the referrer and referee computers, causing at least one information unit in the collection corresponding to a displayed identification, to be modified.

Storing may involve storing a referral status flag, representing a status of the referral, in an information unit of the collection, and setting the referral status flag to a first value to indicate that the collection has not yet been viewed by the referee. The method may involve setting the referral status flag to a second value if at least one information unit of the collection has been displayed at the referee computer.

The method may further involve (a) facilitating uploading of a file from one of the referrer and referee computers in response to upload signals received therefrom; (b) storing the file in association with a collection associated with both the referrer and the referee; and (c) facilitating downloading of the file to one of the referrer and referee computers in response to download signals received therefrom.

Identifying collections may involve identifying collections having a referral status flag satisfying a referral status criterion.

Identifying collections may further involve establishing the criterion based on at least one of the referrer identifier and the referee identifier. Establishing the criterion may involve setting the criterion to a predefined criterion selected from a set of predefined criteria, in response to a selection signal, in the second set of signals, selecting the predefined criterion, each predefined criterion in the set being based on one of the referrer identifier and the referee identifier.

Identifying collections may further involve identifying collections including at least one of the referrer identifier and the referee identifier.

Causing at least one information unit to be modified may involve setting a modification flag in an information unit associated with the collection corresponding to a displayed identification. Setting the modification flag may involve storing a modification flag value in the modification flag to represent a modification command received in the fourth set of signals. The method may further involve, if the collection corresponding to a displayed identification is caused to be displayed at one of the referrer and referee computers, resetting the modification flag.

Identifying collections may further involve identifying collections having a modification flag satisfying a modification criterion so that identifications corresponding to collections having information units that have been modified in accordance with the modification criterion, are displayed.

The method may involve presenting, at at least one of the referrer and the referee computers, a representation of the modification flag.

Displaying identifications may involve listing labels respectively associated with the collections. Displaying identifications may further involve using different display parameters for different labels to distinguish at least one label from another, and the method may further involve associating a set of display parameters associated with a selection criterion with labels of collections that satisfy the selection criterion.

Storing may involve storing information including at least one of a client name or identifier, a client date of birth, a need, an urgency status associated with the need, a referrer name, and a referee name.

Storing may further involve producing a class identifier classifying the referral into a pre-defined classification, in response to the first set of signals, and storing the class identifier in an information unit associated with the collection. The method may involve causing at least one question to be presented to an operator of the referrer computer, receiving a response to the at least one question, and producing the class identifier in response to the response to the at least one question.

Identifying collections may include identifying collections that have class identifiers satisfying a criterion. The method may involve causing at least one question to be presented to an operator of the referrer computer and receiving a response to the at least one question, and storing the response to the at least one question in information units associated with the collection. A notification may be caused to be transmitted to the referrer computer when the response to the at least one question does not satisfy a validation criterion.

Displaying identifications may further involve displaying identifications in an order dependent upon at least one information unit in each collection corresponding to a displayed identification.

An event log may be associated with the collection and an entry may be added to the event log in response to occurrence of an event involving modification of at least one information unit of the collection in response to the fourth set of signals. Adding an entry to the event log may involve associating a chronological order indicator and an identification of the event with each other. The identification of the event may include an identification of the referrer or referee computer from which the fourth set of signals was received. The method may involve facilitating viewing of the event log from at least one of the referrer and the referee computers.

The method may involve, in response to receiving the fourth set of signals from the one of the referrer and referee computers, causing a message to be sent to the other of the one of the referrer and the referee computers.

The method may involve transmitting information, including information units from the database and including computer-readable codes, to one of the referrer and referee computers, the computer-readable codes being operable to cause a processor circuit at the one of the referrer and referee computers,
(i) to cause at least some of the transmitted information to be displayed at the one of the referrer and referee computers; and
(ii) to facilitate generation, in response to user input at the one of the referrer and referee computers, of communication signals for transmission from the one of the referrer and referee computers, the communication signals including at least one of the first, second, third and fourth sets of signals.

In accordance with another aspect of the invention, the aforesaid computer-readable codes may be provided. The computer-readable codes may be interpretable by a markup language interpreter.

The third set of signals may include a selection signal indicating selection of the collection corresponding to a displayed indication. Moreover, the third and fourth sets of signals may be the same.

Causing at least one information unit in the collection corresponding to a displayed indication to be modified may involve limiting which information units may be modified according to whether the fourth set of signals are received from the referrer computer or the referee computer.

The method may involve identifying a computer as being associated with the referrer or the referee, in response to a respective referrer or referee key associated with the referrer or referee respectively, received from the computer.

The method may involve linking the identifications with a display interface operable to cause information units in a corresponding collection to be displayed.

In accordance with other aspects of the invention, there may be provided a signal encoded with computer-readable codes for directing a processor circuit to perform the above method, and/or a computer-readable medium comprising codes for directing a processor circuit to perform the above method.

In accordance with another aspect of the invention, there is provided a computer-generated user interface soliciting responses from a user that are provided to a computer having a memory with computer-executable codes operable to cause the computer to perform the aforesaid method, in response to the responses.

In accordance with another aspect of the invention, there is provided an apparatus to facilitate management of referrals from a referrer to a referee. The apparatus includes: storing provisions, responsive to a first set of signals received from a referrer computer, for storing, in a database, information pertaining to a referral from the referrer to the referee, the information being stored as a collection of linked information units, the information units including a referrer identifier identifying the referrer as originator of the information and a referee identifier identifying the referee as intended recipient of the information, the collection representing the referral and being accessible by the referrer computer and a referee computer; collection identification provisions, responsive to a second set of signals received from one of the referrer and referee computers, for identifying, in the database, collections of information units that satisfy a criterion, and for causing identifications to be displayed at the one of the referrer and referee computers, the identifications corresponding to respective collections of information units satisfying the criterion; information display provisions, responsive to a third set of signals received from the one of the referrer and referee computers, for causing at least one information unit in a collection corresponding to a displayed identification, to be displayed at the one of the referrer and referee computers; and information modification provisions, responsive to a fourth set of signals received from the one of the referrer and referee computers, for causing at least one information unit in the collection corresponding to a displayed identification, to be modified.

In accordance with another aspect of the invention, there is provided an apparatus to facilitate management of referrals from a referrer to a referee. The apparatus includes a database interface operable to control a database, the database interface being operable to store, in the database, information from a referrer computer, the information pertaining to a referral from the referrer to the referee, the information being stored as a collection of linked information units, the information units including a referrer identifier identifying the referrer computer as originator of the information and a referee identifier identifying a referee computer as intended recipient of the information, the collection representing the referral. The apparatus further includes a filter operable to cause the database interface to identify, in the database, collections of information units that satisfy a criterion, and to cause identifications to be displayed at one of the referrer and referee computers, the identifications corresponding to respective collections of information units satisfying the criterion. The apparatus further includes a client interface cooperating with the database interface and filter and operable to communicate with and be controlled from the referrer and referee computers, the client interface comprising: a referral creation facility operable to facilitate causing the database interface to store the information as the collection in response to signals received from the referrer computer; an information display facility operable to facilitating viewing, from the one of the referrer and referee computers, of at least one information unit in a collection identified by the filter; and an information modification facility operable to facilitate causing a modification, from the one of the referrer and referee computers, of at least one information unit in a collection identified by the filter, wherein the filter is operable to identify the collection when the collection satisfies the criterion and to cause an identification corresponding to the collection to be displayed at the one of the referrer and referee computers.

The database interface, the filter and the client interface may be implemented by a processor circuit. The processor circuit may include a processor and memory in communication with the processor, the memory being encoded with codes for directing the processor to effect the database interface, the filter and the client interface.

The codes may include codes for directing the processor to store a referral status flag in an information unit of the collection and to set the referral status flag to a first value to indicate that the collection has not yet been viewed by the referee. The codes may include codes for directing the processor to set the referral status flag to a second value if at least one information unit of the collection has been displayed at the referee computer.

The codes may include codes for directing the processor to identify, in the database, the collections of information units that satisfy the criterion.

The codes may include codes for directing the processor to identify collections having a referral status flag satisfying a referral status criterion.

The codes may include codes for directing the processor to identify collections including at least one of the referrer identifier and the referee identifier.

The client interface may be further operable to cooperate with the database interface to: (a) facilitate uploading a file, into the database, from one of the referrer and referee computers in response to upload signals received therefrom; and (b) facilitate downloading the file, from the database, to one of the referrer and referee computers in response to download signals received therefrom.

The codes may include codes for directing the processor to store a modification flag in an information unit of the collection and to set the modification flag to a first value to indicate that the collection has not yet been modified. The codes may include codes for directing the processor to set the modification flag to a second value when the information modification facility is controlled, from the one of the referrer and referee computers, to cause a modification to the collection identified by the filter. The codes may include codes for directing the processor to set the modification flag to a third value when the information display facility is controlled, from the other of the referrer and referee computers, to cause display of the collection identified by the filter. The codes may include codes for directing the processor to store a value in the modification flag, the value representing a modification command received by the information modification facility from the one of the referrer and referee computers.

The codes may include codes for directing the processor to identify collections having a modification flag satisfying a modification criterion so that identifications corresponding to collections having information units that have been modified in accordance with the modification criterion, are displayed.

The codes may include codes for directing the processor to cause a representation of the modification flag to be presented at at least one of the referrer and the referee computers.

The information display facility may cooperate with the filter to cause labels respectively associated with the collections satisfying the criterion to be displayed at the one of the referrer and referee computers using a first set of display parameters. The information display facility may cooperate with the filter to cause labels associated with collections satisfying an additional selection criterion to be displayed at the one of the referrer and referee computers using a second set of display parameters in order to distinguish labels associated with collections which satisfy the additional selection criterion from labels associated with collections that do not.

The collection may include at least one of a client name or identifier, a client date of birth, a need, an urgency status associated with the need, a referrer name, and a referee name.

The referral creation facility may be operable to produce a class identifier classifying the referral into a pre-defined classification in response to receiving the information, the referral creation facility being operable to cause the database interface to store the class identifier in information units associated with the collection.

The client interface may be operable to cause at least one question to be presented to an operator of the referrer computer, to receive a response to the at least one question, and to cause the database interface to store the response.

The client interface may be operable to cause a notification to be transmitted to the referrer computer when the response to the at least one question does not satisfy a validation criterion.

The filter may cause identifications to be displayed in an order dependent upon at least one information unit in each collection corresponding to a displayed identification.

The database interface may be operable to maintain an event log for each collection and the client interface may be operable to cause the database interface to update the event log to add an entry to the event log in response to occurrence of an event involving the information modification facility being controlled from one of the referrer and referee computers to cause a modification to at least one information unit of the collection, wherein the entry includes at least one of a chronological order indicator, an identification of the event, and an identification of the one of the referrer and referee computers from which the modification was caused.

The information display facility may be operable to be controlled from the one of the referrer and referee computers to cause display of the event log thereat.

The information modification facility may respond to receiving the modification command from one of the referrer and referee computers by facilitating sending a message therefrom to the other of the referrer and referee computers.

The client interface may be operable to transmit information, including information units from the database and including computer-readable codes, to one of the referrer and referee computers, the computer-readable codes being operable to cause a processor circuit at the one of the referrer and referee computers,
(i) to cause at least some of the transmitted information to be displayed at the one of the referrer and referee computers; and
(ii) to facilitate generation, in response to user input at the one of the referrer and referee computers, of communication signals for transmission from the one of the referrer and referee computers to the client interface.

The client interface may be operable to receive, from the one of the referrer and referee computers, a selection signal indicating selection of the collection identified by the filter, and to cause the information display facility to cause an information unit of the collection identified by the filter to be displayed at the one of the referrer and referee computers in response thereto.

The apparatus may further include an authentication facility operable to identify a computer from which signals are received as being associated with a user, in response to receiving from the computer a user key associated with a user identifier identifying the user.

The client interface may be further operable to establish the criterion based on the user identifier.

The client interface may be further operable to cause the filter to use, as the criterion, a predefined criterion selected from a set of predefined criteria, in response to a selection signal received from the computer, indicating the predefined criterion.

In accordance with another aspect of the invention, there is provided a data structure facilitating the communication of information pertaining to a referral from a referrer to a referee, the structure comprising a collection of linked information units pertaining to the referral, at least some of the information units of the collection being operable to be modified, the information units of the collection including: a referrer identifier identifying a referrer computer as being originator of the collection, the referrer computer being associated with the referrer; a referee identifier identifying a referee computer as an intended recipient of the collection, the referee computer being associated with the referee; and a modification flag operable to indicate that a modification was made, from one of the referrer and referee computers, to at least one information unit of the collection. The data structure may be encoded on a computer-readable medium.

The information units of the collection may further include an event log operable to store an entry indicating occurrence of an event.

The information units of the collection further include a referral status field operable to indicate a referral status comprising at least one of an unread status signifying that the collection has not been viewed from the referee computer, an appointment set status signifying that an appointment has been set for the referral represented by the collection, a cancelled status signifying that the referral represented by the collection has been cancelled, and a completed status signifying that the referral represented by the collection has been completed by the referee.

The information units of the collection may further include at least one of a client name or identifier, a client date of birth, a need in respect of which the referral is made, an urgency status associated with the need, a referrer name, and a referee name.

The information units of the collection may further include at least one of a wait list priority field indicating a priority of the referral represented by the collection in a waitlist of the referee, a wait list status field indicating a status of the referral in the waitlist, a waitlist reason field indicating a reason for placing the referral on the waitlist.

The information units of the collection may further include at least one of a referral date sent field, a referral type field, a referral identifier field, a notes field, a client contacted field indicating whether the client was contacted about the referral, a certainty flag for indicating a level of certainty regarding a diagnosis, a referral status field, an appointment time field, a referral reason field, an appointment cancellation reason field, a carbon copy field, a payer field, an attached files status field, and an archived status field.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a referral management system according to a first embodiment of the invention, the system including a server and a plurality of client computers communicating therewith;

FIG. 2 is a block diagram of the referral management system shown in FIG. 1;

FIG. 3 is a schematic representation of a user interface depicting a main menu and a user summary display seen upon successful login into the system of FIG. 1;

FIG. 4 is a schematic representation of a patient selection page, produced in response to actuation of a make referral button on the main menu shown in FIG. 3;

FIG. 5 is a schematic representation of a selected patient page produced in response to actuation of a link shown in FIG. 4;

FIG. 6 is a schematic representation of a referring MD page produced in response to actuation of a continue button on the page shown in FIG. 5;

FIG. 7 is a schematic representation of a first consultant information page produced in response to actuation of a continue button on the page shown in FIG. 6;

FIG. 8 is a schematic representation of a MD search results page produced in response to actuation of a name link shown in FIG. 7;

FIG. 9 is a schematic representation of a second consultant information page produced in response to actuation of a name link shown in FIG. 8;

FIG. 10 is a schematic representation of a first problem/procedure selection page produced in response to actuation of a continue button shown in FIG. 9;

FIG. 11 is a schematic representation of a second problem/procedure selection page produced in response to actuation of continue button shown in FIG. 10;

FIG. 12 is a schematic representation of a notes page produced in response to actuation of a notes & files button shown on in FIG. 11;

FIG. 13 is a schematic representation of a referral summary and submission page produced in response to actuation of a summary button shown on the referral menu bar in FIG. 12;

FIG. 14 is a representation of a collection of linked information units, representing a referral from a referrer to a referee, and stored at a database of the system shown in FIGS. 1 and 2;

FIG. 15 is a schematic representation of a display representing incoming referrals to a user of the system shown in FIGS. 1 and 2;

FIG. 16 is a schematic representation of a display produced in response to selection of a referral represented in FIG. 15;

FIG. 17 is a schematic representation of a wait list page produced in response to actuation of a wait list button shown on the referral menu bar in FIGS. 3 and 15;

FIG. 18 is a schematic representation of a user interface for facilitating the sending of messages by a user of the system shown in FIGS. 1 and 2;

FIG. 19 is a schematic representation of an incoming messages page produced in response to actuation of an incoming message button show in FIGS. 15 and 18;

FIG. 20 is a schematic representation of a message page produced in response to actuation of a hyperlink shown in FIG. 19.

FIG. 21 is a schematic representation of a user interface for facilitating updating of problems or needs addressed by a user of the system shown in FIGS. 1 and 2;

FIG. 22A & 22B are a flow chart illustrating an exemplary series of low-level transactions between a client computer and the server of the system of FIGS. 1 and 2;

FIG. 23 is a simplified communication flow diagram illustrating a plurality of high-level transactions between a referring party (i.e., referrer) and a consulting party (i.e., referee) in respect of a referral, using the system shown in FIGS. 1 and 2.

### DETAILED DESCRIPTION

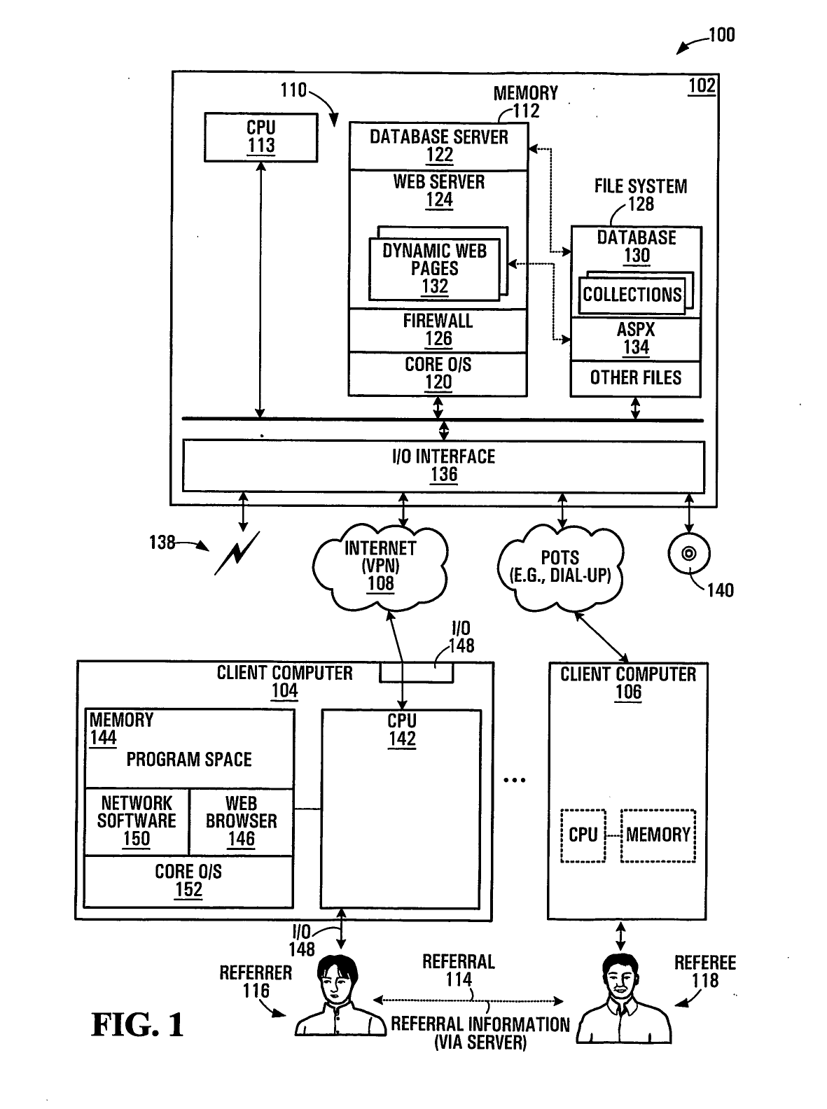

Referring to FIG. 1, a referral management system for facilitating management of referrals from a referrer to a referee, according to a first embodiment of the invention, is shown generally at 100. Generally, the system includes a referral management apparatus such as a server 102 and a plurality of client computers (e.g., 104, 106) operable to communicate with the server using a communication method, which may include a network 108, such as the Internet, a public-switched telephone network (PSTN), WiFi, Ethernet™, or any other suitable communication method or combination of methods. The network 108 may further include a virtual private network (VPN) or an alternate mechanism for ensuring secure communication between the client computers (e.g. 104, 106) and the server 102. A communication protocol such as TCP/IP or any other suitable protocol may be used to implement network communications. The server 102 includes a processor circuit 110, which, in this embodiment, includes a memory 112 in communication with a processor 113, the memory being encoded with codes for directing the processor to effect the functionality of the server as described below. Similarly, each client computer 104, 106 has a respective processor circuit, which includes a processor and a memory encoded with codes for directing the processor to control the functionality of the respective client.

Although the system illustrated in FIG. 1 can accommodate any number of client computers, for ease of illustration, FIG. 1 depicts only two client computers, the first computer being a “referrer client computer” 104 associated with a referrer 116 and the second computer being a “referee client computer” 106 associated with a referee 118. The referrer client computer 104 is used by or on behalf of a referring user to transmit information pertaining to a referral 114, via the server 102, to a user at the referee client computer 106. The user at the referee client computer 106 may be the intended referee 118, or a person acting on behalf of the intended referee.

For example, the referrer 116, associated with the referrer client computer 104, may be a referring physician, such as a general practitioner making medical referrals in respect of his or her patients, and the referee 118, associated with the referrer client computer 106, may be a consulting physician, such as a specialist who accepts referrals, including referrals from the general practitioner. Additionally, the system 100 facilitates agents acting on behalf of the referrers and referees. For example, a client computer may be controllable by a medical office assistant (MOA) to send or receive electronic referrals on behalf of a physician with whom the assistant is associated. In some cases, the referrer 116 or the referee 118 may be an institution rather than a person (e.g., a hospital or clinic), and also may have a plurality of agents acting on its behalf.

The embodiments described herein are related to medical referrals, and therefore certain pairs of terms (“referrer” and “referring physician”; “referee” and “consulting physician”) are used somewhat interchangeably. However, such usage is not intended to limit the present invention to the medical field. While the particular embodiments described herein to illustrate the invention support medical referrals, the broad principles behind these embodiments could be applied within referral management systems in other fields of endeavour.

A principal user may alternately act as either a referrer or referee in different transactions. Accordingly, a client computer (e.g. 104, 106) in this system is typically operable to both send and receive electronic referrals. Thus, the characterizations used herein of a client computer being either a referrer or referee computer should be understood as being descriptive only in respect of particular transactions performed from the client computer involving either the sending or receiving of an electronic referral, respectively. In other words, the same client computer could be characterized as a referrer computer in one transaction but as a referee computer in another.

Similarly, while this description refers to a “referrer” 116 and a “referee” 118 as individuals, operating a “referrer client computer” 104 and “referee client computer” 106 respectively, this is merely to conveniently illustrate embodiments of the invention for particular transactions involving at least one referral 114 originating from the “referrer” 116 and addressed to the “referee” 118. However, it will be appreciated that such language is illustrative and not limiting. A user may act as a referrer in respect of one referral and as a referee in respect of another. Moreover, any number of users of the system 100 may interact with each other by means of the system. Effectively, the embodiments described are intended for use by a plurality of referrers sending a plurality of referrals to a plurality of referees, such that different referrals may be sent to different referees, and such that some of the referrers may also be referees and vice versa.

In this embodiment, the server 102 utilizes software including an operating system 120, a database server 122, and a web server 124. The operating system 120 may include Microsoft Windows 2000 Server™, the database server 122 may include Microsoft SQL Server™, and the web server 124 may include Microsoft Internet Information Services (IIS)™. The operating system 120 may include the database server 122 and the web server 124, and other relevant network software such as a firewall 126, for example. The server 102 may include a file system 128 for storing files accessible by the web server 124. The file system may support a database 130 and related files accessible by the database server 122.

The database server 122 is operable to control the database 130, in response to signals received from the web server 124. The web server 124 is operable to communicate with the plurality of remote client computers 104, 106 and to present dynamic web pages 132 thereto. In the embodiment shown, dynamic web pages 132 are Active Server (ASP) pages generated in accordance with computer-readable codes based on ASPX executable files 134 compiled from Visual Basic™ source code using Microsoft .NET™ tools. The dynamic web pages 132 are operable to cause various displays to be seen at the client computers 104, 106 and to receive user input therefrom as described herein. A helpful description of ASPX execution is provided in U.S. Patent Application Publication No. US 2004/0029092 A1, incorporated herein by reference. It will be appreciated by those skilled in the art that the present system need not be implemented by using ASP pages under the Microsoft .NET™ framework, and that other languages and communication methods could be substituted (such as Java™ for example).

Regardless of whether the functionality of the system described herein is implemented by dynamic web pages or by Java™, or by direct hosting at the server 102, or by a combination of these or other methods, any implementation will include three main functions including a database interface function, a filter function and a client interface function. Together, each of these functions may be referred to as a set of interdependent services. Each set of interdependent services will be implemented by codes executing on either the server 102 processor 113, on a processor at the client computer, or both. For example, the codes implementing a given function may be split such that one portion of the codes runs on the server 102 and another portion runs on the client processor 142. For example, some of the functionality of the system may be implemented by code embedded in dynamic web pages. In the embodiment shown, some of the functionality of the system is implemented by code embedded in ASP pages that are transmitted from the server 102 to the client processor (142), for example, for execution at the client processor and some of the functionality of the system is implemented by code executed at the server 102.

Generally, the software to direct the server 102 to perform the methods of this invention may be received or installed through an I/O interface 136 of the server 102, and may be communicated, for example, through the network 108, through a dial-up connection, through a computer-readable signal 138, or through a computer-readable medium 140 such as a CD-ROM, floppy disk, or flash memory, for example, encoded with blocks of codes for directing the processor 113 to undertake particular processing steps.

Client computers, such as client computer 104, generally include a CPU or client processor 142 and memory 144 and require no special software in this embodiment except for a web browser 146 such as Microsoft Internet Explorer™, which may be provided as part of an operating system 152 of the client computer (e.g., Microsoft Windows XP™). The operating system 152 may also include networking software 150 to enable access to a server such as 102 at a remote location. The client computers may have I/O interfaces 148 similar to those of the server 102.

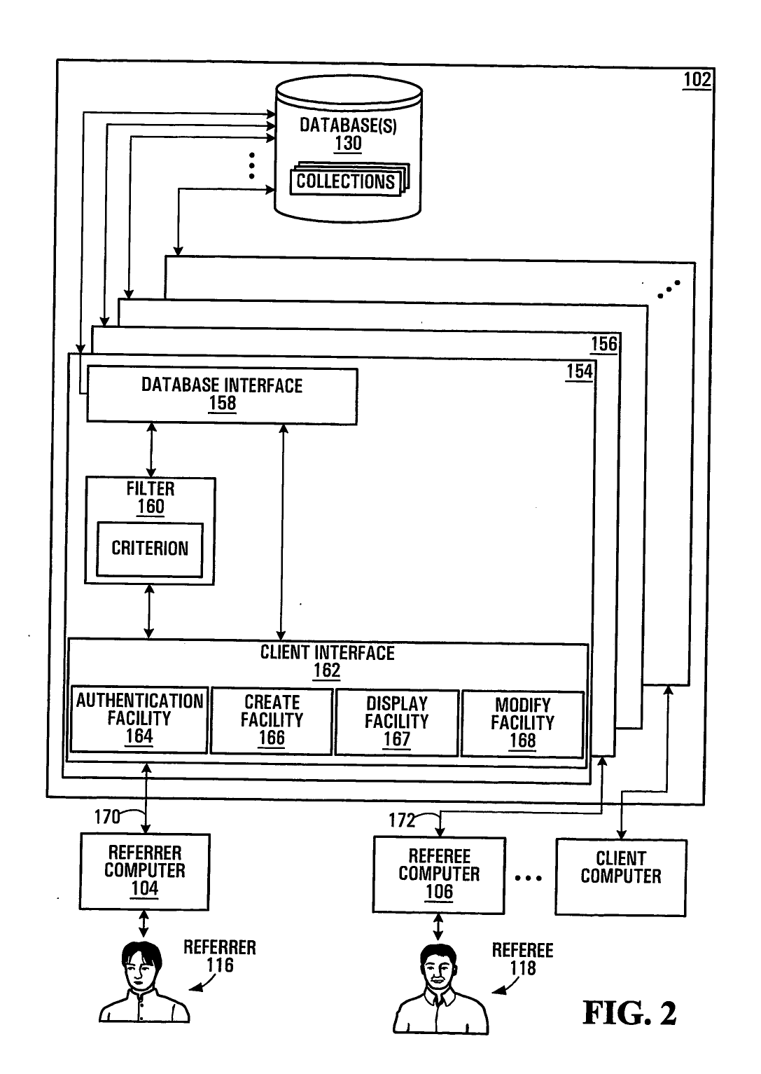

For ease of explanation, a generic representation of three main functional components of the system is provided in FIG. 2.

Referring now to FIG. 2, the server 102 is configured to invoke respective instances of code 154, 156 to provide a respective set of interdependent services to each client computer 104, 106 engaged in a communications session with the server 102. Each set of interdependent services includes a database interface 158, a filter 160 and a client interface 162.

Generally, the database interface 158 is operable to control a database 130 to store, in the database 130, information from a referrer or referee computer. The information may pertain to a referral from the referrer 116 to the referee 118. The information is stored in the database 130 as a collection of linked information units including a referrer identifier identifying the referrer client computer 104 (associated with the referrer 116) as originator of the information, and a referee identifier identifying a referee client computer 106 (associated with the referee 118) as intended recipient of the information. The collection of linked information units thus represents a referral.

The filter 160 is operable to cause the database interface 158 to identify collections of information units that satisfy a criterion, and to cause identifications of such collections to be displayed at a client computer such as the referrer client and referee client computers 104, 106.

The client interface 162 cooperates with the database interface 158 and cooperates with the filter 160 to facilitate viewing and modifying of information stored in the database 130. The client interface 162 is operable to communicate with and be controlled from the referrer or referee client computers 104, 106. The client interface 162 may optionally include an authentication facility 164, to provide for user authentication before permitting access to the server 102 by an inquiring referrer or referee computer.

The client interface 162 includes a referral creation facility 166 operable to facilitate causing the database interface 158 to store information received from the referrer computer 104, for example, as a collection of information units in response to signals received from the referrer computer 104. The client interface 162 further includes an information display facility 167 operable to facilitating viewing, from the referrer and referee client computers 104, 106, of at least one information unit in a collection identified by the filter 160. The client interface 162 further includes an information modification facility 168 operable to facilitate causing a modification, from the referrer and referee client computers 104, 106 of at least one information unit in a collection identified by the filter 160.

The client interface 162 is operable to cause communication signals 170 or 172, encoded with information, to be transmitted from the server 102 to a client computer (e.g., 104 or 106) The information may include information units from the database 130 and may further include computer-readable codes operable to cause a processor (e.g., 142 in FIG. 1) at the client computer to cause at least some of the transmitted information to be displayed at the client computer. The computer-readable codes may effect a user interface at the client computer such as a graphical user interface (GUI). The computer-readable codes may be further operable to cause the processor (142) at the client computer to facilitate generation of communication signals (also indicated by 170 or 172) for transmission from the client computer to the client interface 162, in response to user input at the client computer. The codes provided to the client computer by the host computer may include computer-readable codes embedded in dynamic web pages and interpretable by a markup language interpreter. For example, SGML codes (such as HTML) interpretable by a web browser 326 may be transmitted to the client computer 104. The computer-readable codes may alternatively, or in addition, include programs such as applets, scripts (e.g., JavaScript), objects, inclusions and/or links which are executable by the client computer to cause display of information thereat and/or to facilitate user interactivity.

In the embodiment described, the dynamic web pages produced by the server 102 produce the user interface seen at a client computer and may be operable to solicit user responses, for transmission back to the server 102, via input elements such as text boxes, buttons, lists, drop-down list boxes, radio buttons, and hyperlinks, for example. A user may manipulate or select an input element thereby causing a data or selection signal associated with that input element to be transmitted back to the server 102. In effect, the client interface 162 not only causes signals to be transmitted to client computers to cause various displays thereat, but it also receives signals from the client computers, based on user input thereat, and processes the received signals or forwards them to other software components at the server 102, as appropriate, to implement the methods described herein.

Operation

Authentication Facility

Referring to FIG. 2, generally, it is desirable that a user undergo authentication by the server 102 (by “logging in”) before he or she is allowed to access services provided by the server software. In cases where the server 102 and client computers 104, 106 are connected by a Virtual Private Network (VPN) within the network 108, the user may be required to undergo more than one level of authentication. For example, the user may first log in to the VPN, and then login to the system 100 to establish a communication session therewith. The authentication facility 164 facilitates this login.

Effectively, the authentication facility 164 is operable to direct the server 102 to identify a computer from which signals are received as being associated with a particular user, in response to receiving from that computer a user key associated with a user identifier identifying that particular user. The authentication facility 164 directs the server 102 to determine whether the user identified corresponds to an authorized user of the system before establishing a communication session with that user.

To establish a communication session, the referrer 116 may use the client computer 104 to request a login page from the server 102, for example, by entering a network address of the server 102 into an address line of the web browser (146) on the client computer 104. This causes the authentication facility 164 to cooperate with the web server (124) to send a login page to the client computer 104 for display in its web browser.

The referrer 116 then enters a login token and/or password associated with the referrer into the login page, and causes his/her client computer to transmit the login token and/or password back to the server 102. The authentication facility 164 directs the server 102 to determine whether the login token and/or password received from a client computer corresponds to a user identifier associated with an authorized user of the server 102, and if so, the authentication facility 164 directs the server to associate the client computer with the authorized user, and enables the authorized user to proceed using the referral system 100 from that client computer. This constitutes a successful login.

In this embodiment, a physician may login under his or her own account, or alternatively, a physician or an MOA can login using a clinic account which may have multiple physicians associated therewith.

In response to a successful login, the client interface 162 automatically directs the server 102 to select and transmit an opening dynamic web page to the client computer. The opening dynamic web page is executed and displayed at the client computer 104 to which it was transmitted.

Opening Page

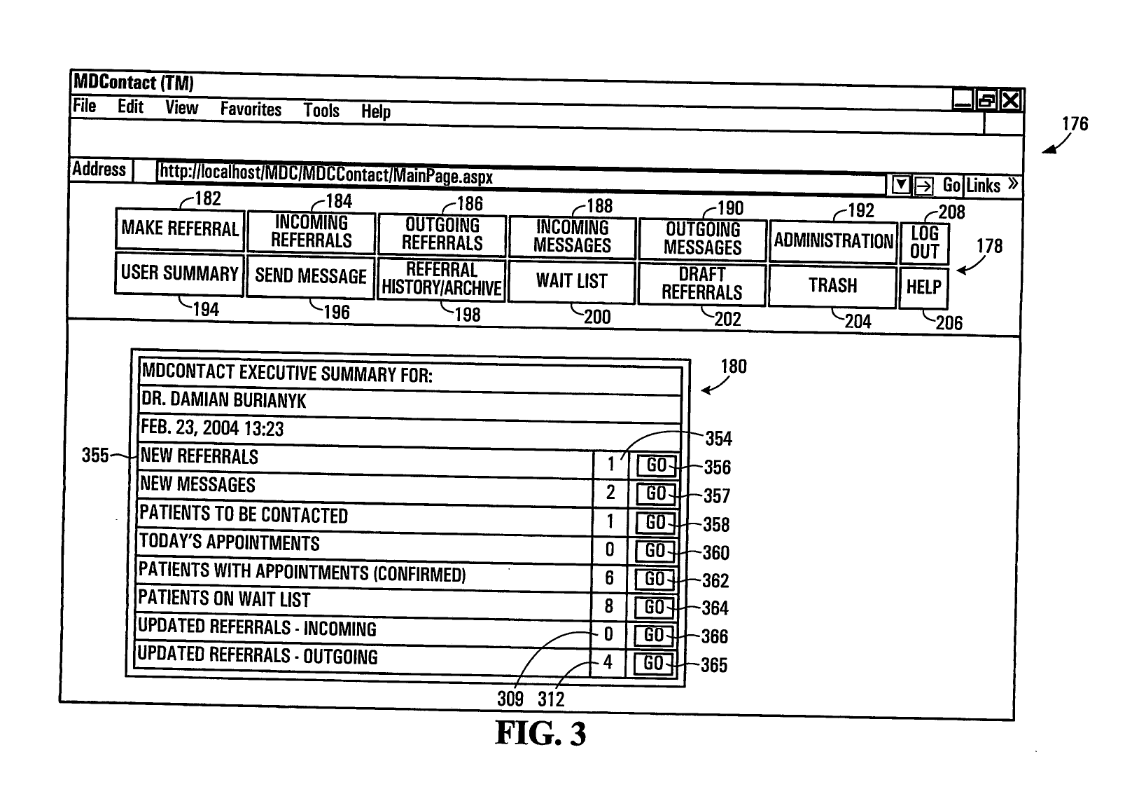

An exemplary opening dynamic web page is shown at 176 in FIG. 3. The exemplary opening dynamic web page includes a menu bar 178 and an executive summary 180. The menu bar 178 includes buttons 182-208 that are associated with codes embedded in the dynamic web page that direct the client computer to initiate functionality at the client computer and/or at the server (102). The executive summary 180 is produced by code embedded in the dynamic web page, which is executed by the client computer when the page is received at the client computer. Referring to FIGS. 2 and 3, this code directs the client computer 104 to produce a display template and cooperates with the client interface 162 to cause the filter 160 and database interface 158 to obtain information from the database 130 to populate the template with information from the database to produce the summary, as shown. Criteria used by the filter 160 are pre-established default criteria contained within the opening dynamic web page and associated with the executive summary 180.

The menu bar 178 is treated as a unit. The web server (124 in FIG. 1) may be configured with a plurality of dynamic web pages that include an instance of this menu bar and the functionality associated with it. In other words, the menu bar 178 need only be created once for the opening dynamic web page and can be replicated for each other dynamic web page on which it is desired to be used.

The menu bar 178 includes a make referral button 182 associated with code that causes the client computer and server (102) to cooperate to create an electronic referral. An incoming referral button 184 is associated with code that causes the client computer and server (102) to cooperate to cause a list of incoming electronic referrals for the user to be displayed. An “Outgoing Referrals” button 186 is associated with code that causes the client computer and server to cooperate to cause a list of outgoing electronic referrals made by the user to be displayed. An Incoming Messages button 188 is associated with code that causes the client computer and server to cooperate to cause incoming messages for a user to be listed. An Outgoing Messages button 190 is associated with code that causes the client computer and server computer to cooperate to cause outgoing messages for a user to be listed. An Administration button 192 is associated with code that causes the client computer and server to cooperate to permit a user (e.g., physician) or agent of the user (e.g., medical office assistant MOA) to update user information, update problem-related information associated with the current user, or update clinic accounts associated with the current user.

A Send Message button 196 is associated with code that causes the client computer and server to cooperate to facilitate a user of the system sending a message to another user. A Referral History/Archive button 198 is associated with code that causes the client computer and server to cooperate to display a history and summary log of every referral sent for a specific patient, or in some embodiments this button may also be associated with code that directs the server and client computer to cooperate to display a summary log of all cancelled or completed referrals for a specific physician. A Wait List button 200 is associated with code that causes the client computer and server to cooperate to display a summary of all the active referrals put by a consulting physician on his or her waitlist. A Draft Referrals button 202 is associated with code that causes the client computer and server to cooperate to display a log of partly-completed referrals that may be stored until the referrer decides to complete the referrals.

A Message Trash button 204 is associated with code that causes the client computer and server to cooperate to display a list of deleted messages, possibly for a limited period of time, before they are permanently removed from the system. A Help button 206 is associated with code that causes the client computer and server to cooperate to display instructions to the user. A User Summary button 194 is associated with code that causes the client computer and server to cooperate to display the executive summary shown at 180 in FIG. 3. The Logout button 208 is associated with code that causes the client computer and server to cooperate to end the communications session with the server 102.

Effectively, the code associated with the incoming referrals button 184, the outgoing referrals button 186, the incoming messages button 188, the outgoing messages button 190, the referral history/archive button 198 and the wait list button 200 respectively, cooperates with the client interface 162, which cooperates with database interface 158 and the filter 160, to cause the filter to filter the database records according to criteria associated with the particular function identified by the respective button, and causes a display associated with that function to be produced at the client computer.

If the user of the client computer actuates any of the buttons on the menu 178, code associated with that button is executed at the client computer to initiate at the server 102 the process or functionality to which the button relates.

Creating a Referral

Actuation of the make referral button 182 of the main menu 178 invokes code in the current dynamic web page that causes a signal to be sent from the client computer to the client interface (162), and specifically to the referral creation facility (166), for a “new referral” dynamic web page, of a set of new referral pages, for receiving user input in connection with making a referral. The referral creation facility (166) cooperates with the web server (124) to produce and send to the client computer a first referral page.

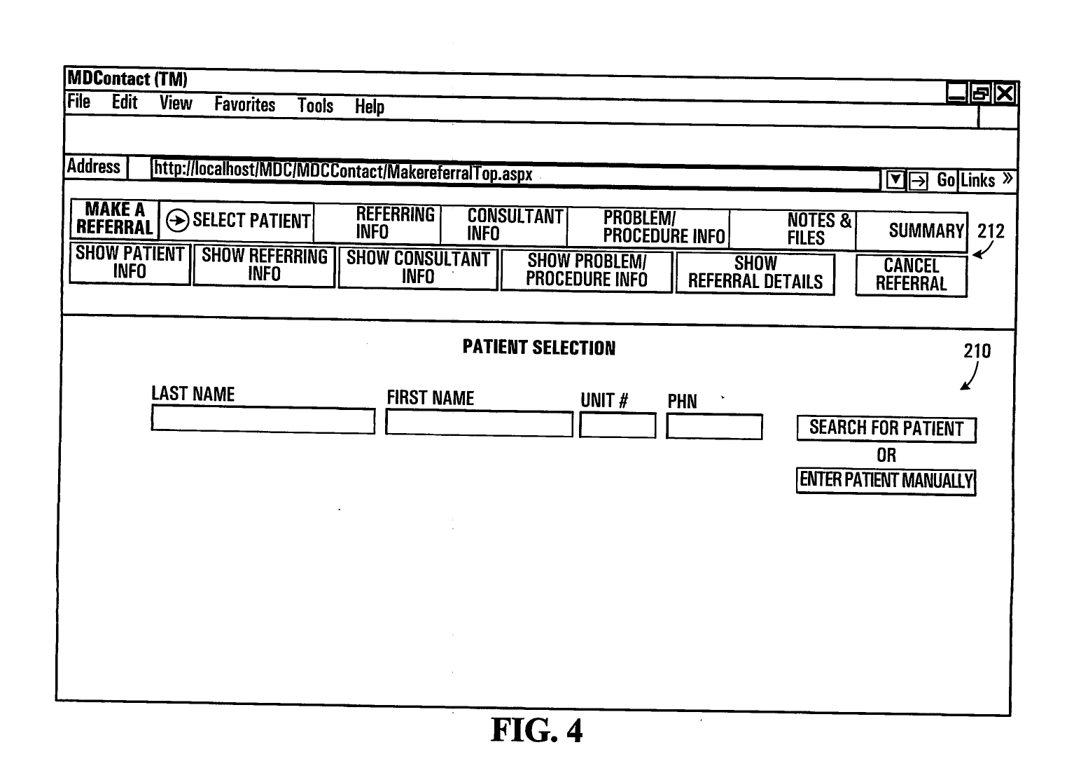

An exemplary first referral page is shown at 210 in FIG. 4. This page facilitates patient selection through manual entry of patient information or through lookup in a patient database that may be maintained on the database 130, to identify a patient with whom the referral is to be associated. In the latter case, the referral creation facility (166) may facilitate the user searching a referring physician's database, a clinic's database, or an independent database containing patient information, and transmitting any information found to the server 102.

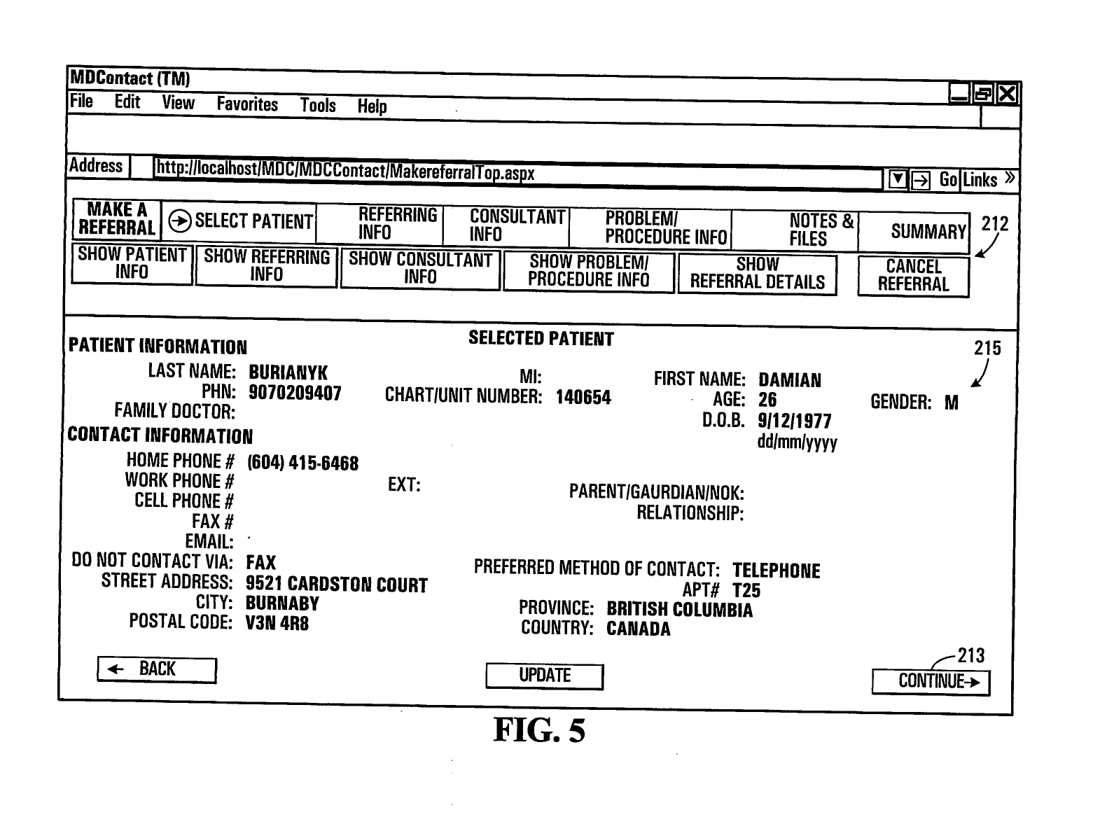

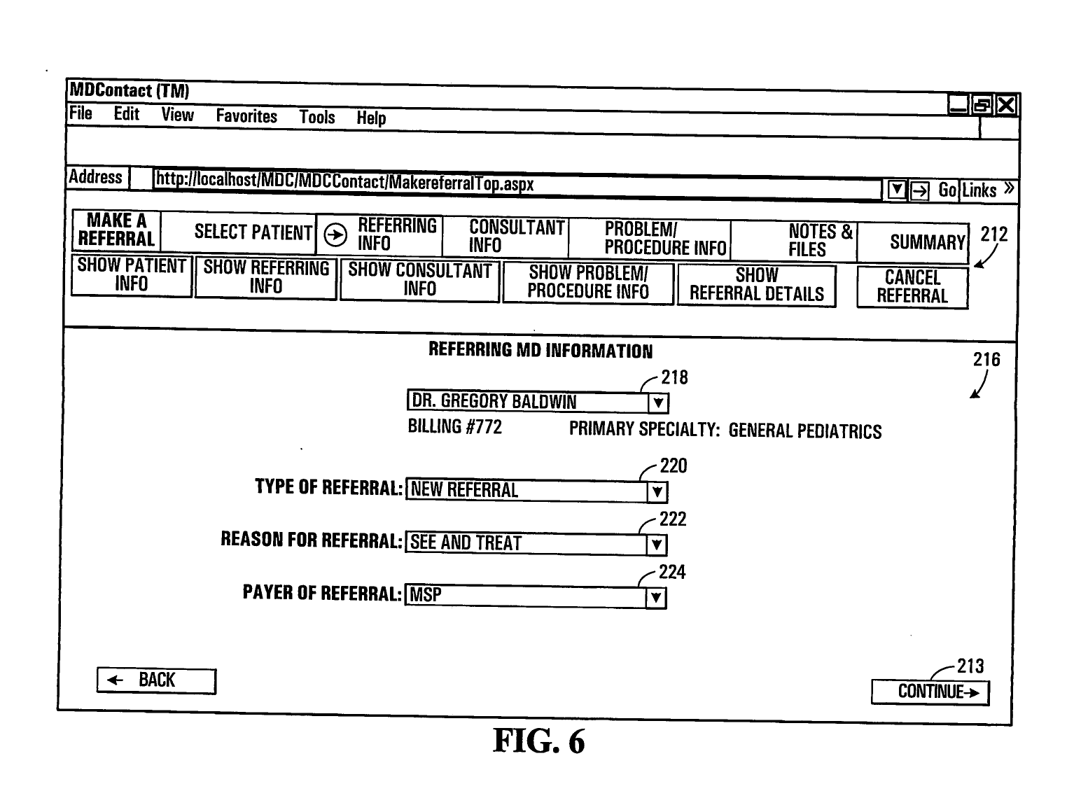

A referral menu bar 212 is included within the first referral page 210 and includes code that enables the user to link to a second page as shown at 215 in FIG. 5, which facilitates entry of further information regarding the patient, if not already provided through database lookup. This second page 215 includes a continue button 213 which further permits linking to a referring MD page as shown at 216 in FIG. 6.

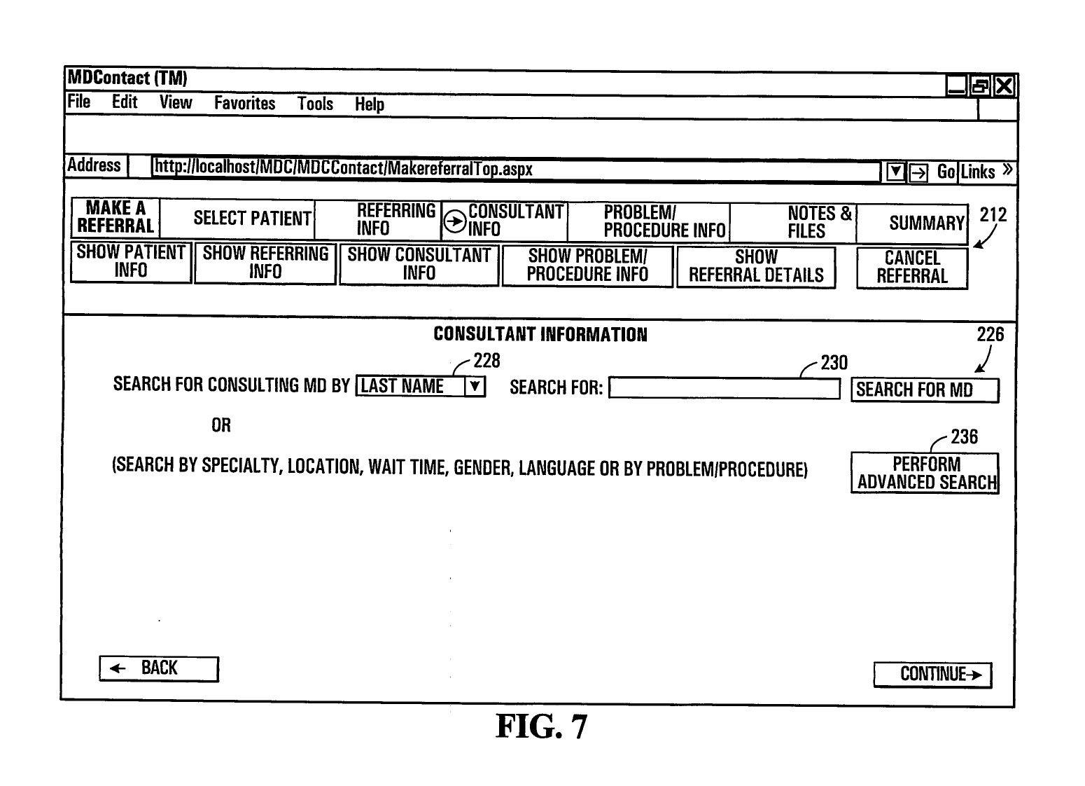

Referring to FIG. 6, the referring MD page 216 may include entry boxes 218-224 with drop down menus that link to databases of names of doctors, types of referrals, reasons for referrals, and payers for services rendered in connection with referrals. In this embodiment, a logged-in physician can send referrals from himself or herself, and a medical office assistant (MOA) logged in under a clinic account can choose a physician from a list of physicians associated with the clinic. The referring MD page 216 further includes a continue button 213 which facilitates linking to a consultant information page 226 as shown in FIG. 7.

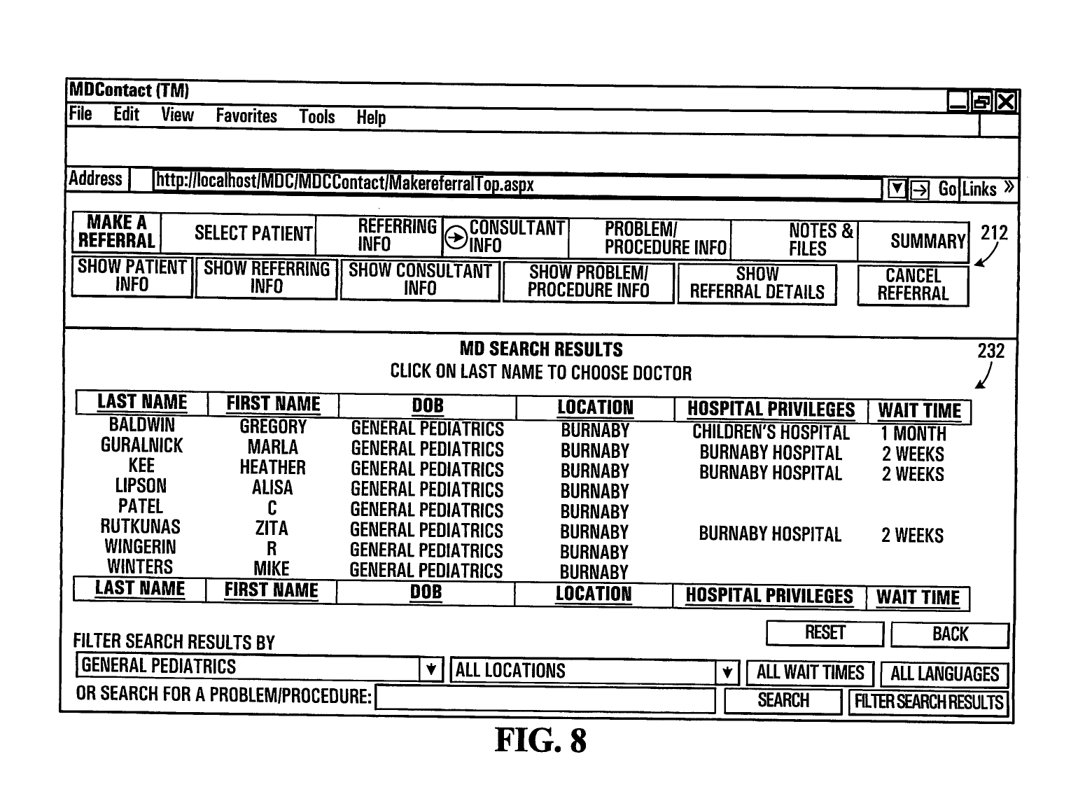

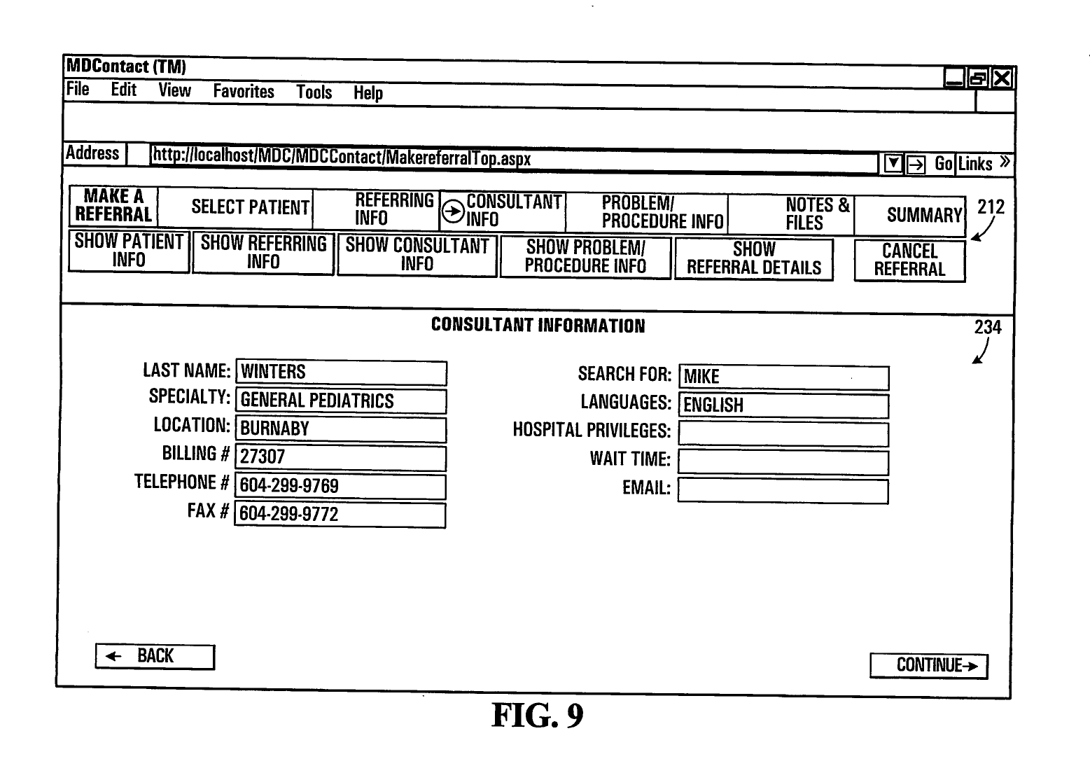

Referring to FIG. 7, the consultant information page includes search entry boxes 228 and 230 that are linked to databases that facilitate searching for consulting MD's by name. In addition, this page includes an advanced search button 236 that facilitates searching by specialty, location, wait time, gender, language, problem/procedure, or any other parameter. Selection of a name in box 228 causes the server to produce a dynamic web page as shown at 232 in FIG. 8 which provides a hyperlinked list of possible candidate MDs satisfying the entered criteria. The user may select one of the indicated candidates by clicking on the corresponding hyperlink, which causes the server to produce a consultant detail dynamic web page as shown at 234 in FIG. 9.

Referring to FIG. 9, the consultant detail 234 page lists details of the selected consultant. If the user is the actual consultant selected, the information shown may be edited. Otherwise, the consultant information may only be viewed.

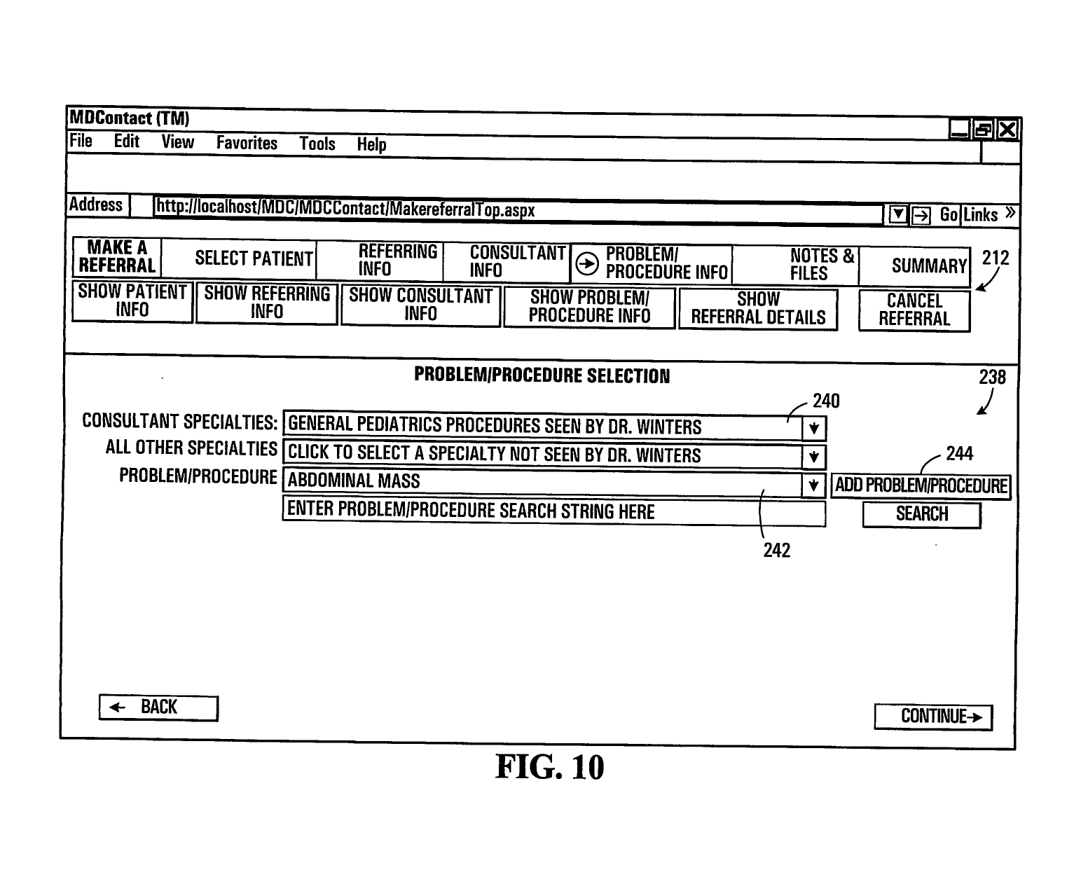

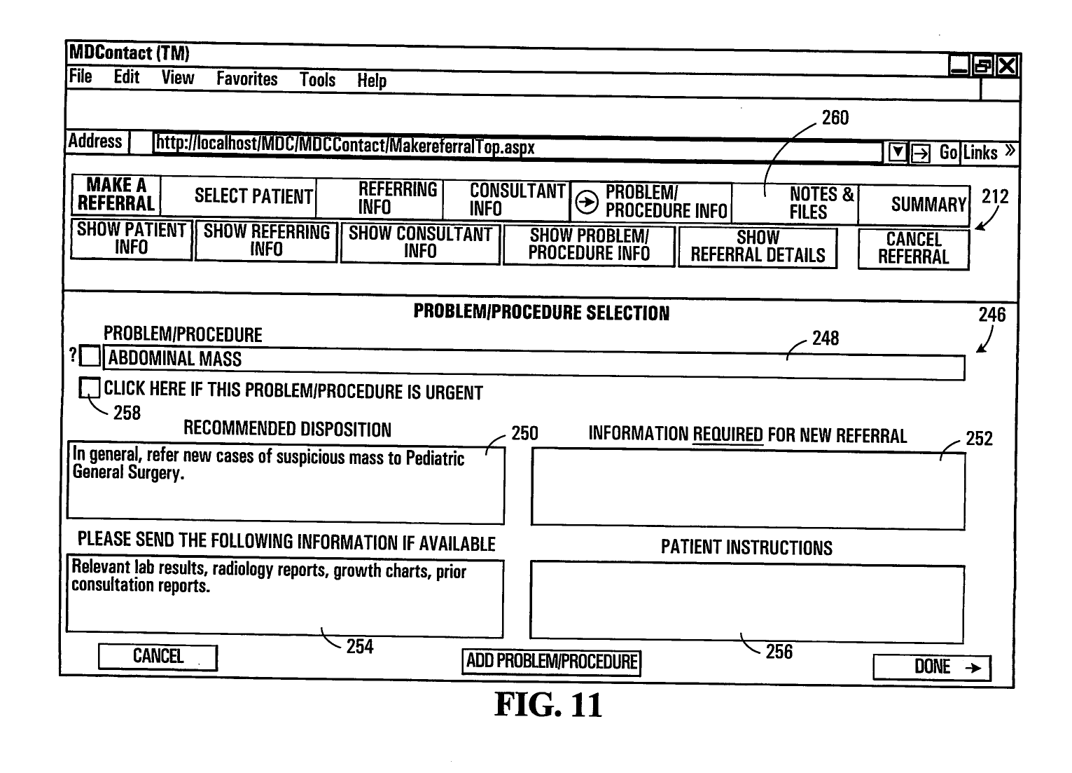

Referring back to FIG. 7, actuation of the advanced search button 236 causes the server to produce an advanced search dynamic web page as shown at 238 in FIG. 10. The advanced search dynamic web page 238 includes a first drop down box 240 for selecting one of a plurality of consultant specialties and includes a second drop down box 242 for selecting one of a plurality of problems. The consultant specialties and problems are pre-stored in a sub-database of the database (130) to facilitate lookup as indicated. The advanced search page 238 also has an add button 244 that, when actuated, associates the problem indicated at 242 with the referral and links to a problem entry dynamic web page as shown in FIG. 11.

Referring to FIG. 11, the problem entry page 246 facilitates viewing of information relating to a problem, including a problem identifier 248, recommended disposition 250, information required for new referrals 252, a list of information required 254 and patient instructions 256. A box 258 is provided to enable the user to indicate whether the problem is urgent. Alternatively additional boxes or user input features may be provided to facilitate user entry of the level of urgency of the problem or to indicate “unsure” if the identity or nature of the problem is unclear (e.g., the referring physician is not fully confident in his or her preliminary diagnosis). In some embodiments, if the problem is not already selectable in the drop-down list boxes, the user may be allowed to enter the problem manually.

When problem information is entered by the user, the server may display problem-specific instructions directed to the referring physician and/or to the patient. The instructions may be based on predefined instructions provided by the system, or they may be custom instructions pre-entered by the consulting physician, as will be described below. For example, for a surgery case, a note may be displayed in box 254 for the referring physician, requesting that the latest kidney X-ray be provided to the consulting physician, and other notes may be displayed in box 256 to provide patient instructions such as not to eat for 24 hours prior to the appointment. (Patient-specific instructions may be conveyed to the patient by the referring physician or an MOA.)

Similarly, the referral creation facility (166) may cause the host processor to dynamically generate instructions for display in one of the boxes 250, 252, 254, 256, based on the selection of the problem, for example, or based on a series of diagnostic questions that may be presented in one of the boxes 250, 252, 254, 256 or in an alternative user interface display, such as in a pop-up dialogue box, for example. Thus, for example, a referring physician (e.g., referrer 116) may be notified that a patient ought to be sent urgently and directly to a hospital emergency room or be sent urgently to visit a consulting physician (e.g., referee 118) in his or her office. Similarly, the referring physician may be given instructions regarding what medical tests ought to be initiated for this patient to facilitate the acceptance or expeditious handling of the referral by the consulting physician. In this way, the consulting physician may communicate, at an early stage of the referral, the types of information that will need to be provided or gathered by the referrer for the benefit of the consulting physician. In other cases, the dynamically-generated instructions may simply inform the referrer (116) that the referee (118) will not accept this kind of referral, given the information received from the referrer (116) (e.g., the responses to the diagnostic questions). In this embodiment, the instructions generated by the server (102) may include instructions for the patient as well, which the referring physician (or an MOA) can convey to the patient.

Thus, the referral creation facility (166) may cause one or more questions, such as the above-mentioned diagnostic questions, to be presented to a user of the referrer computer (104), to receive a response to the question or questions from the user, and to cause the database interface (158) to store the response(s) in the database (130) in association with the collection of linked information units representing the present referral. For example, in the case of a medical referral, the referrer (116) may be queried regarding patient symptoms and/or what medical tests have been performed on the patient. The referral creation facility (166) may cause a notification to be transmitted to the referrer computer (104) if the response to the question does not satisfy a validation criterion. For example, if in response to the aforesaid query, the referrer (116) indicates that he or she has not initiated a particular medical test which is considered essential, a warning message may be annunciated to the referrer computer (104) to this effect. In some embodiments, the referral creation facility (166) may go further and decline to allow the collection to be stored in the database as representing a valid referral if this particular validity criterion is not met.

More particularly, the dynamic web page shown in FIG. 11 may direct the server (102) to present a series of questions to the referring physician based on predefined questions stored in the database (130) relating to the condition/problem or procedure in question. The database (130) may be populated by a plurality of sets of default diagnostic questions associated with respective problems/procedures, which may have been designed in consultation with experts. The questions may form a diagnostic questionnaire, comprising, for example, a dozen commonly-asked questions by consulting physicians in respect of that problem or procedure. In some embodiments, the default questions may be customizable by a referring physician using the functionality described in connection with the Administration procedures described below. Responses by the referring physician may be stored in the database (130) for future access by others, such as the consulting physician. The responses may help the consulting physician to get at least some of the information necessary to properly address the problem presented by the patient.

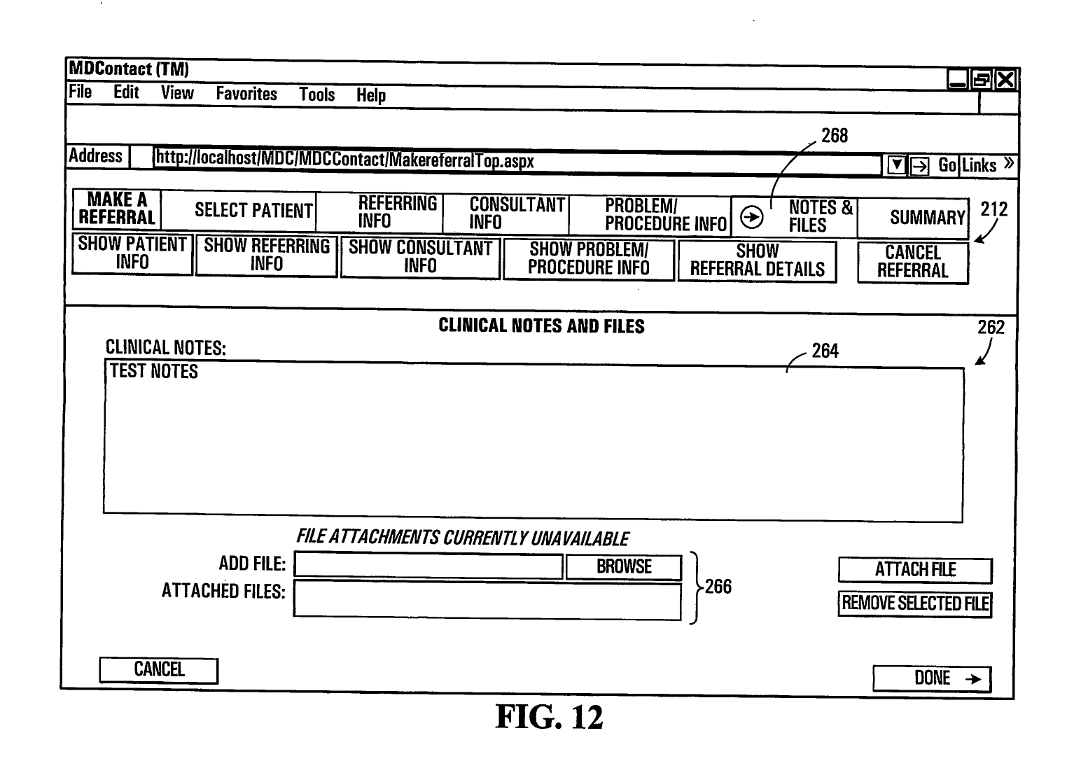

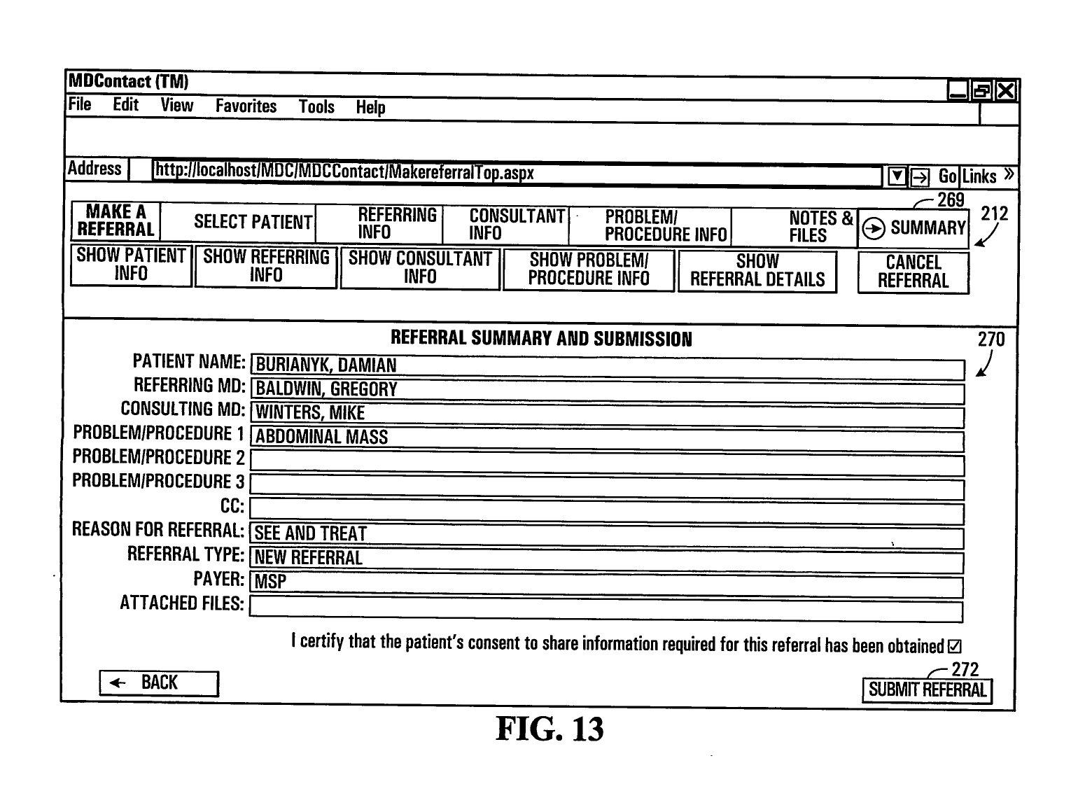

Referring to FIG. 11, the referral menu 212 further includes a button 260 for entering notes and attaching files, which when actuated, causes the server to produce an dynamic web page as shown at 262 in FIG. 12. This page 262 includes a text box 264 for user entry of clinical notes and includes a file attachment facilitator 266 permitting a user to identify and attach files stored locally at the client computer. Files may include digitized representations of X-ray images, for example. After adding notes as shown in FIG. 12, the user may actuate a “done” button to indicate entry of information is completed and this may cause the server 102 to cause a page as shown in FIG. 13 to be displayed at the client computer.

Referring to FIG. 13, the referral menu 212 further includes a summary button 269, which when actuated, causes the server to produce a dynamic referral summary as shown at 270. This summary includes a summary of information pertaining to the referral and includes a submit referral button 272 which invokes code that causes a signal to be sent to the client interface (162) to cause it to store the referral in the database (130).

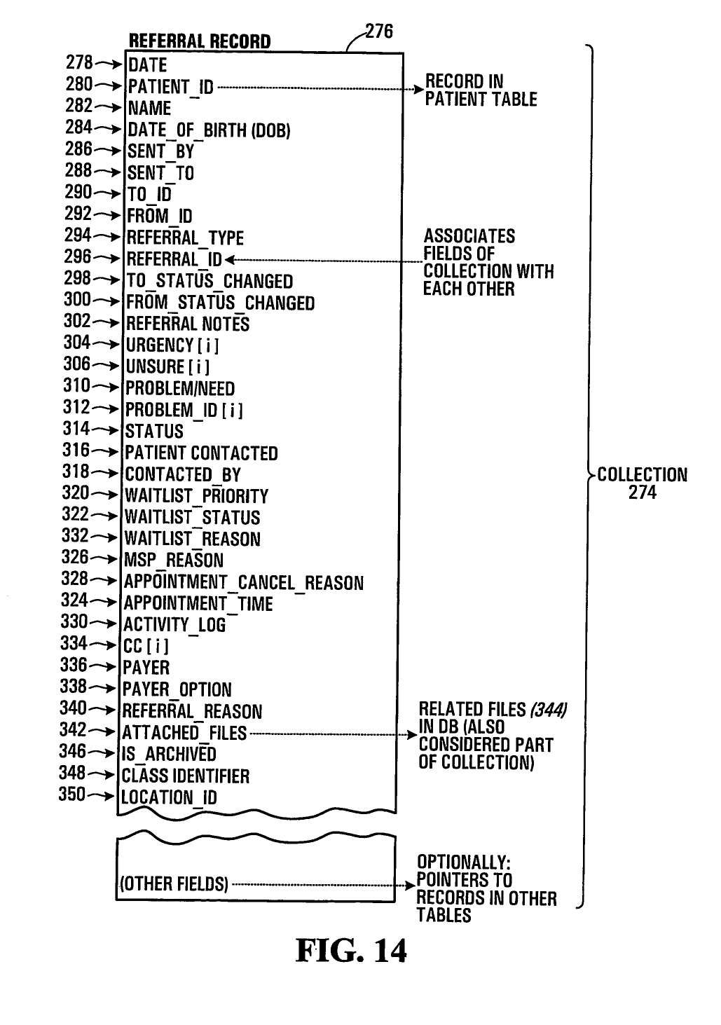

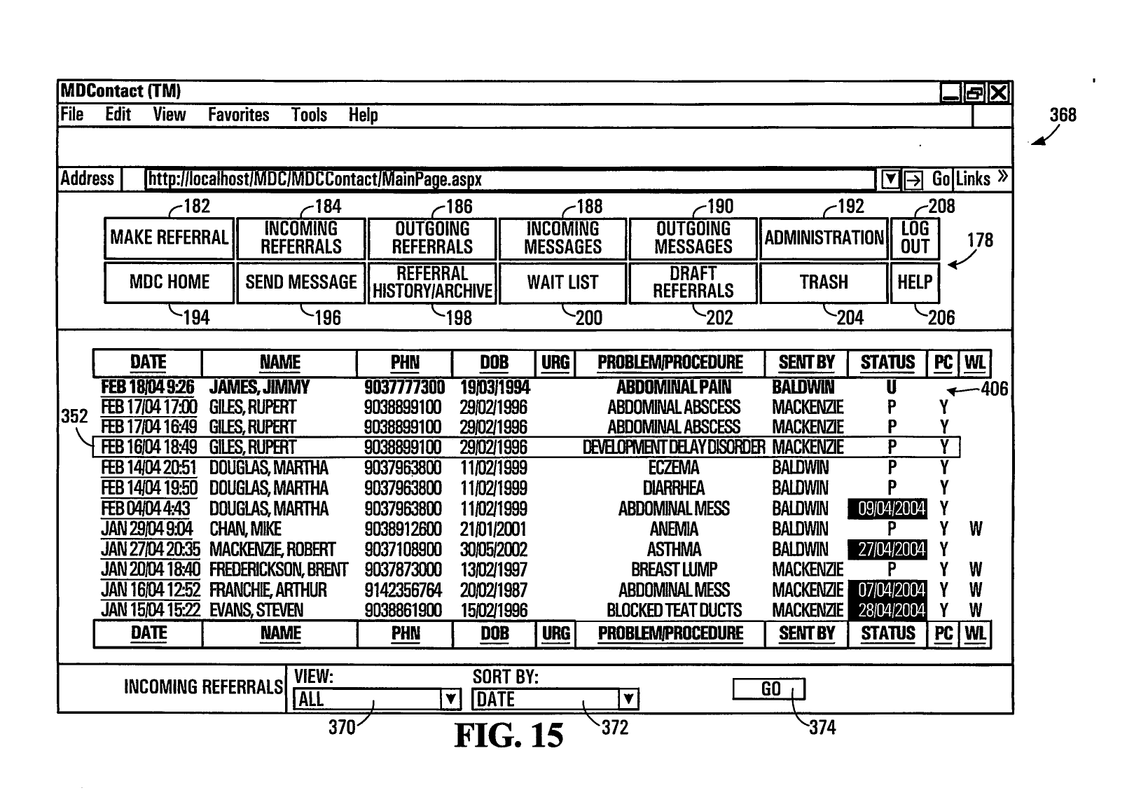

The effect of the referral information entry process provided by the above described dynamic web pages is to create a collection such as shown generally at 274 in FIG. 14, to validate the collection and then store it in the database.

Referring to FIG. 14, on actuation of the make referral button (182) of the main menu (178), the referral creation facility directs the server to set up a data structure for accumulating and temporarily storing, in scratchpad memory at the server, a collection 274 of information units representing information entered by the user through the referral entry pages described above. The collection 274 may be structured to include a referral record data structure 276. Once a collection 274 of information units has been prepared, when the user actuates the submit referral button 272 shown in FIG. 13, the collection is validated against a list of rules, and if valid, is sent to the database interface (158) for storage in the database (130) as a valid referral collection 274, which is implemented in part in this embodiment by the referral record 276. Although, in this embodiment, the referral record 274 may contain most of the information units pertaining to a referral, it should be understood that the collection 274 may further include additional information units (for example, uploaded files) which are not stored in fields in the referral record 274, but which are nonetheless linked so as to be part of the collection 274 of linked information units representing the referral.

In this embodiment the data structure of the referral record 276 includes the fields outlined in Table 1 below, for storing related information units associated with a referral.

TABLE 1
Fields of Referral Record (276)

Date 278 - date and time of when the referral was made. The contents
of this field may be derived from the system date and time known by
the client computer or the server computer 102.
PatientID 280 - unique ID for patient (e.g., personal health number),
The “PatientID” field 280 of the referral record 276 may include a
pointer to a record in a patient table of the database 130 containing
patient information.
Name 282 - formatted name of the patient,
Date of Birth (DOB) 284- date of birth of the patient,
SentBy 286 - name of the sender (e.g., referring physician),
SentTo 288 - name of the receiver (e.g., consulting/referee physician),
ToID 290 - unique ID of person to whom referral was sent (e.g., billing
number of consulting/referee physician),
FromID 292 - unique ID of person who sent the referral (e.g., billing
number of referring physician),
ReferralType 294 - type of referral (In this embodiment: this field may
hold an indicator identifying the referral as a referral, a re-referral of
more than 6 months old, re-referral of less than 6 months old, a follow-
up referral from in-patient care, a follow-up referral from specialist
appointment, or other types of referrals),
ReferralID 296 - unique ID generated for the referral, this field
associates the other fields of this collection to each other, and may be
used as an index to find information units located in other database
tables which are related to this referral,
ToStatusChanged 298 - holds change/update notifications for the
referee (118). Such notifications may relate to any modifications made
to the referral by a referring physician, for example. The referee may
be notified as a result of changes of the contents of this field. In this
embodiment, the ToStatusChanged field 298 is operable to represent
combinations of the following modifications to the information units of
the collection 274:

| | |
|---|---|
| (a) | an appointment request to the referee (118), made by the |
| | referrer (116) using an information modification facility (168) of |
| | the server (102), the appointment request representing a |
| | request from the referrer (116) that the referee (118) set up an |
| | appointment for the client associated with the referral (114); |
| (b) | an appointment change request to the referee (118), made by |
| | the referrer (116) using the information modification facility |
| | (168), the appointment change request representing a request |
| | from the referrer that an existing appointment for the client be |
| | rescheduled by the referee; |
| (c) | an appointment cancellation request to the referee (118), made |
| | by the referrer (116) using the information modification facility |
| | (168), representing a request that the referee cancel the existing |
| | appointment; |
| (d) | a waitlist request to the referee (118), made by the referrer (116) |
| | using the information modification facility (168), representing a |
| | request that the referee (118) add the client to his or her waitlist |
| | for appointments; |
| (e) | a waitlist priority change request to the referee (118), made by |
| | the referrer (116) using the information modification facility |
| | (168), representing a request that the waitlist priority of the client |
| | on the referee's waitlist be changed; |
| (f) | a waitlist removal request to the referee (118), made by the |
| | referrer (116) using the information modification facility (168), |
| | representing a request that the client be removed from the |
| | referee's waitlist; and/or |
| (g) | a “notes updated” status, indicating that the referrer (116) has |
| | updated (i.e., appended information to) the notes associated |
| | with the collection 274 and stored in a ReferralNotes field 302, |
| | for the referee (118) to view; and/or |
| (h) | a “referral cancelled” status, indicating that the referrer (116) has |
| | unilaterally cancelled the referral 114. |

FromStatusChanged 300—holds change/update notifications for the referrer (116), such as any modifications made to the referral (114) by the referee (118), such as a consulting physician, for example. The referring physician may be notified of changes to the contents of the field. The FromStatusChanged field 300 in this embodiment is operable to represent combinations of the following modifications to information units of the collection 274:
(a) an “appointment made” status, indicating that the referee (118) has set an appointment for the client associated with the referral (e.g., (114)) represented by the present collection 274;
(b) an “appointment changed” status, indicating that the referee (118) has changed the client appointment associated with this referral (114);
(c) an “appointment cancelled” status, indicating that the referee (118) has cancelled an appointment for the client for this referral (114);
(d) an “added-to-waitlist” status, indicating that the referee (118) has added the client for this referral to the referee's waitlist;
(e) a “waitlist priority changed” status, indicating that the referee (118) has changed the waitlist priority associated with this referral (114);
(f) a “removed-from-waitlist” status, indicating that the referee (118) has removed this referral (114) from the referee's waitlist;
(g) a “notes updated” status, indicating that the referee (118) has updated (i.e., appended information to) the notes associated with the collection 274 representing this referral (114), the notes being stored in the ReferralNotes field 302, for the referrer (116) to view; and/or
(h) a “referral cancelled” status, indicating that the referee (118) has unilaterally cancelled the referral (114).

In this embodiment, ToStatusChanged and FromStatusChanged fields 298, 300 of the referral record 276 may separately or together be regarded as a modification flag.

To facilitate tracking modifications made to a collection 274, the client interface 162 cooperates with the database interface 158 to associate a modification flag with the collection. Effectively, the modification flag may be used to identify collections which were modified by one party to a referral and/or to track the nature of the modification made, in order to provide a notification of the modification to the other party to the referral, for example. In this embodiment, collections modified by one party may be “marked” accordingly in the modification flag, at least until the other party has viewed the modification by invoking the information display facility (167). Thus, modifications caused by the referrer (116) may remain marked until viewed by the referee (118), and vice versa. However, it will be appreciated that it may not be essential for every modification made to a collection 274 to be marked in the modification flag; certain trivial modifications made to a collection by one party to a referral may simply not be worth bringing to the attention of the other party to the referral.

In this embodiment, the referral creation facility (166) initially sets the modification flag to a first value or status to indicate that the collection has not yet been modified. For a referral sent between two parties, the information modification facility (168) is further operable to set the modification flag to a second value or status, differing from the first value, when the information modification facility (168) is controlled, from one party's computer, to cause a modification to the collection 274. The information display facility (167) is also operable to set the modification flag to a third value or status when the information display facility (167) is controlled, from the other party's computer, to select this newly modified (i.e., updated) collection 274 for viewing thereat. The third value may equal the first value if it is desired to reset the modification flag to its original state to indicate that a collection 274 has no modifications made to it by a modifying party which have not been viewed by a non-modifying party.

It will be appreciated that the modification flag may alternatively be implement by a single binary flag, implemented in a single field, for example. However, the modification flag may effectively comprise a plurality of modification sub-flags, operable to be set independently to respective pluralities of different values.

Continuing on with the description of the fields of the referral record data structure 276, the data structure in this embodiment further includes the following fields.

ReferralNotes 302—clinical notes associated with the referral. Both the referrer (116) and referee (118) can append notes to this field.

Urgency[i] 304—urgency of condition i (boolean); in this embodiment, i=1 . . . 3;

Unsure[i] 306—unsure of condition i (boolean)—certainty level associated with a preliminary diagnosis of the referrer; in this embodiment, i=1 . . . 3;

Problem 310—Condition/Procedure 1;

ProblemID[i] 312—ID of a need or condition i associated with this referral, such as an identity of a disease sought to be treated in the patient; in this embodiment, i=1 . . . 3;

Status 314—a referral status flag field comprising a referral status flag representing a status of the referral associated with this collection. In this embodiment, the referral creation facility (166) is operable to cooperate with the database interface (158) to store the referral status flag in the referral status flag field 314 of the collection 274, and to set the referral status flag to a first value to indicate that the collection has not yet been viewed by the referee (118) (i.e., it is “unread”). Other components of the server (102) may be operable to modify the referral status flag in response to signals received from the referrer or referee computers (104, 106). In this embodiment, the following referral statuses are of interest and are represented by the referral status flag:
(a) unread: a status indicating that this collection has not yet been selected for viewing from a computer associated with the designated referee of the collection;
(b) pending: a status indicating that the referral represented by this collection has been selected for viewing from a computer associated with its designated referee, but no appointment has been set;
(c) appointment set: a status indicating that an appointment has been set for the referral represented by this collection;
(d) cancelled: a status indicating that the referral represented by this collection has been cancelled; and
(e) complete: a status indicating that the referral represented by this collection is complete.

Effectively, the referral creation facility (166) cooperates with the database interface (158) to initially store a referral status flag set to a first value to indicate that the collection has not yet been viewed by the referee (118). The information display facility (167) causes the referral status flag to change to a second value to replace the first value, if at least one information unit of the collection 274 is displayed at the referee computer (106) using the information display facility (167). For example, the information display facility may cause the referral status flag field 314 of a collection viewed by the referee indicated in its referee field to be changed from an “unread” status to a “pending” status to reflect the fact that the collection 274 is no longer unread by the referee (118).

Whereas, in this embodiment, the contents of the referral status flag field 314 of each collection 274 can be set to one of a plurality of different statuses or values, it will be appreciated that in other embodiments, storage of these and other referral-related statuses or flags could be implemented in a variety of ways, such as in independently controllable status flags, possibly stored in separate information units, whether in the referral record 276 or elsewhere, for example.

Continuing on with the description of the field of the referral record data structure 276, the data structure in this embodiment further includes the following fields:

Patient Contacted 316—a boolean flag indicating whether or not the patient was contacted about the latest changes to this referral;

ContactedBy 318—holds indications of whether the referrer (116) or referee (118) is responsible for contacting the patient;

WLpriority 320—wait list priority (set by referee (118)); in this embodiment, four priority levels are used in association with waitlists;

WLstatus 322—wait list status (boolean) (set by referee (118))—a flag indicating whether or not the patient was put on the referee's waitlist; ApptTime 324—time of appointment with the referee for this referral;

MSPReason 326—reason for referral (Medical Services Plan);

ApptCancelReason 328—reason for cancelling an appointment;

Activity Log 330—activity/event log for referral; the system adds an entry including an indication of any changes made to the referral and a chronological order indicator, such as a timestamp, every time there is a significant event pertaining to the collection, such as a flag, status, or certain kind of information unit change. Each significant event is an entry which becomes a part of a permanent referral history in the Activity Log 330. The referrer (116) and referee (118) have restricted access to this field. They cannot edit or delete past entries in the field. This may be important for liability reasons.

In this embodiment, the activity log field 330 is automatically updated in response to at least the following events: referral sent, referral read, a referral cancellation request (by the referrer), a referral cancellation (by the referee), referral completion (by the referee), an appointment request (by the referrer), an appointment made (by the referee), an appointment change request (by the referrer), an appointment change (by the referee), an appointment cancellation request (by the referrer), an appointment cancellation (by the referee), a waitlist request (by the referrer), patient put on waitlist (by the referee), waitlist priority change request (by the referrer), waitlist priority changed (by the referee), waitlist removal requested (by the referrer), patient removed from waitlist (by the referee), clinical notes added (by the referrer or referee).

In some embodiments, codes may be provided in the input interface so that the referrer (116) or referee (118) may cause the server (102) to add specific entries to the activity log field 330 to record events which may affect liability, such as, for example, an indication that the referee was “unable to contact the patient”. In some embodiments, the activity log need not be implemented in the referral record 276 of the collection 274, and could be stored in a separate file, for example. In this case, an index to the activity log may be provided in the activity log field 330 to link to the separate file.

WLReason 332—reason for a wait list request;

CC[i] 334—Carbon copy of referral was sent to (e.g., billing number of physician) [in this embodiment, i=1 . . . 3];

Payer 336—Information about the payer who will pay for the referral (medical service plan, insurance company, workers' compensation board, etc.);

PayerOption 338—extra info on payer (data entered in text box);

ReferralReason 340—reason for referral (e.g., in this embodiment: see and treat, take over care, answer question, opinion only, second opinion, procedure, other); set by referrer.

AttachedFiles 342—boolean variable indicating whether or not there are files associated with the referral; as seen in connection with FIG. 12, the client interface (162) is operable to cooperate with the database interface (158) to facilitate uploading a file, into the database (130), from a referrer client computer in response to upload signals received therefrom. Similarly, the client interface (162) facilitates downloading the file from the database (130) to the referee client computer in response to download signals received therefrom. The Attached Files flag field 342 includes an “Attached Files” flag, which indicates whether files associated with the referral (e.g., image files such as X-rays) are stored elsewhere in the database (130). Related files associated with the collection 274 may be located by using the “Referral ID” field 296 of the referral record 276 to lookup their file names in an “Attached Files” table in the database (130), for example.

IsArchived 346—boolean variable indicating whether the collection is active, archived, or about to be moved from the active list to the archive within a certain number of days (used to mark an almost-completed/almost-cancelled referral in the inbox/outbox);

Class Identifier 348—In response to receiving information pertaining to a referral, the referral creation facility (166) may produce a class identifier classifying the referral into a predefined classification, and cause the database interface (158) to store the class identifier in the information field 348 shown in FIG. 14. For example, the server (102) may automatically produce a class identifier identifying an appropriate disposition of the referral in response to the information contained in the referral record, based on diagnostic rules stored in the database (130). The class identifier may be based wholly or partly on user responses to questions posed to the user by the client interface (162).

LocationID 350—An identifier representing the location that the referral is going to. This is useful where the referee/consultant has multiple practices at multiple locations.

It will be appreciated that some of the fields in the referral record data structure 274 are updated or determined by processes executed by the server 102 in response to certain user actions and that the contents of some of the fields may be used to determine actions to be taken in a process or the outcome of a process.

In some embodiments, it may be desirable to store fewer, additional, or alternate information units to those shown in FIG. 14, as part of the collection 274. Moreover, the information units of a collection 274 may be distributed across a plurality of files and database tables in partly or fully normalized form in order to improve performance and reduce storage requirements. It will be appreciated that there are many other equivalent ways of storing information pertaining to a referral within the scope of this invention.

Additional Database Tables and Data Structures

It will be appreciated that other database tables and data structures may be used. For example, the server (102) may create new instances of various records in the respective tables or delete existing record instances, as appropriate. The server (102) may also modify existing instances of records by modifying the fields of the records. Moreover, the appropriate columns (i.e., fields) of the various tables may be searched to filter or sort or otherwise format the information that is presented to a user. It may be necessary to link record instances from two or more tables in order to achieve a desired complex search which relies on data spread across the two or more tables. Some of the significant tables used in one embodiment are listed in Table 2.

TABLE 2
Significant Tables Used in One Embodiment

| | |
|---|---|
| ArchiveTable | holds all completed referrals |
| CustomDiagInstructionTable | holds the custom instructions for |
| | each physician for each customized |
| | problem |
| DoctorTable | holds information on physicians |
| MasterProblemTable | complete list of all conditions and |
| | procedures |
| MDSeenProblemTable | the list of problems which each |
| | consulting physician (e.g., specialist) |
| | will see |
| MessageTable | holds all the current messages |
| MessageTrashTable | holds all the messages marked for |
| | deletion |
| PatientTable | holds patient info |
| ReferralFilesTable | holds file location for any files |
| | associated with a referral or message |
| ReferralTable | holds all active referrals |
| RelatedUserTable | stores the list of physicians |
| | associated with a user such as a |
| | MOA. (There may be one entry in |
| | this table for each physician |
| | associated with an MOA.) |
| SpecialtyTable | a list of all the specialties |
| UserTable | stores info on the user |
| FeedbackTable | stores feedback sent from a user to |
| | the system administrators, including |
| | comments, who sent them, and when |
| | they were sent |

Referring to Table 2 above, the Archive table and the ReferralTable may be used to store instances of the referral record 276 (see Table 1 and FIG. 14). The MessageTable and the MessageTrashTable may store instances of a message record similar to the referral record. The other record tables listed in Table 2 may include fields as indicated below.

TABLE 3
CustomDiagInstructionTable

ProblemID - ID of the problem/procedure
billNum - unique billing number of the physician
RefMDInst - custom instructions to the referring physician
PatInst - custom instructions to the patient

TABLE 4
DoctorTable

LName - last name
FName - first name
MiddleInitial - middle initial
BillNum - unique ID for each physician (i.e., their billing number)
specialty[i] - physician's specialty (in this embodiment, i = 1 . . . 3)
PHoneNum - phone number
faxnum - fax number
address - address
location - city
waitTime - physician's average wait time
HospPriv - hospital where physician has operating privileges
UserName - physician's user name
email - email address
cellnum - cell number
worknum2 - alternate phone number
pager - pager number
language[i] - physician's i-th language (in this embodiment, i = 1 . . . 3)
workExt[i] - i-th extension for phone number (e.g., i = 1 . . . 2)

TABLE 5
MasterProblemTable

ProblemID - unique ID for problem
specialty - specialty that the problem belongs to
ICD9 - the medical community's specified code for a problem
Problem - the problem name
RefMDInst - default referring physician instructions
PatInst - default patient instructions
NUWT - default non-urgent waiting time
TestResults - test results required

TABLE 6
MDSeenProblemTable

billnum - ID of physician that will see the problem
ProblemID - ID of problem seen by physician
ISCustom - flag indicating if custom instructions, questions or tests are
present for this problem
Specialty - specialty that the problem belongs to

TABLE 7
PatientTable

LName - last name
FName - first name
MiddleInitial - middle initial
PatientAddress - address
PatientLocation - city
PatientPHN - personal health number
PatientID - unique patient ID
PatientChartNumber - patient chart number
PatientAge - patient age
PatientSex - patient sex/gender
PatientDoctor - patient family physician
PatientDOB - patient date of birth
PatientHomePhone - patient home phone number
PatientWorkPhone - patient work phone number
PatientCellPhone - patient cell phone number
PatientGuardian - patient parent or guardian
PatientGuardianRelationship - nature of relationship to guardian
PatientProblemHistory- historical information relating to patient problem

In some embodiments, there may be a separate patient table for each clinic/user that uses the system (100), such that each clinic/user is separately responsible for providing the contact information for a patient when a referral is made. This arrangement increases the privacy of patient information, and may prevent one clinic/user from overwriting the patient information entered by another clinic/user. Moreover, this arrangement is flexible in that it may allow the patient to provide different information to different clinics/users (e.g., different summer and winter addresses).

TABLE 8
ReferralFilesTable

refID - ID of referral or message
File[i] - location of file i (in this embodiment, i = 1 . . . 5)

TABLE 9
RelatedUserTable

UserID - unique ID of user
RelatedUser - unique ID of related user

TABLE 10
SpecialtyTable
Specialty - each entry in table is a medical specialty

TABLE 11
UserTable

```
LoginName - what a user uses to login with
UserID - the unique user ID
UserType - physician, MOA, clinic administrator
DisplayName - a text “real name” to display (e.g., if you login as KMC,
  it will display Kensington Medical Clinic)
Password - user's password
FailedLogin - stores # of failed logins (if it reaches a certain level,
  account will be frozen)
NewUser - stores whether the account has been used yet or not
LoggedIn - flag to ensure that each person can only login once at a
  time
```

The listings and descriptions of fields for the tables described above are not to be considered as limiting, since other fields consistent with the operation of this embodiment may also be used as appropriate. For example, the various tables may include columns having common keys operable to be used by the database software for cross-referencing data between tables. Furthermore, many tables may have fields such as CreationDate, CreatedBy, ModifiedDate, and ModifiedBy to facilitate tracking changes to the data in those tables.

Other tables may also be used in some embodiments of the invention, as appropriate, such as a CustomDiagQuestions table for including a set of standard (but customizable by the consulting physician) diagnostic questions for a particular problem/need/procedure, or a CustomTestsRequired table for storing a set of standard (but customizable by the consulting physician) medical lab tests that the consulting physician requires be done before a patient is referred for an appointment. Moreover, joint database tables may be used to store a list of all the languages that a physician can speak or understand. For example, LanguageTable may store a list of languages and their associated language identifiers, and RelatedLanguageTable may store user identifiers in association with language identifiers. Similarly, since a physician may have multiple practice locations at various addresses, joint database tables (e.g., LocationTable and RelatedLocationTable) may be used to store a list of all the addresses at which the physician practices, by associating the respective physician's user identifier with the various addresses.

It will be appreciated that there are a variety of equivalent ways, within the scope of the present invention, to store information associated with a referral in a database. In alternate embodiments, some of the above-mentioned tables may be merged with other tables, and some fields may be moved to another table. Moreover, the number, types and sizes of the information units stored in the various tables may also vary between embodiments. This embodiment uses a local relational database ((130) in FIG. 1), however, various alternative database implementations could be used such as a distributed database, an object-oriented database, or a hybrid object-relational database, for example.

Draft Referral Storage

Making a referral may involve the bi-directional communication of data, including files, questions and responses, for example, between the referrer's client computer (104) and the server (102). In this embodiment, this exchange of data takes place over a number of discreet steps, leading to the possibility that an error may be made in one of the steps. If an error is made by the referrer (116) in the foregoing steps, the referrer may go through the preceding steps in reverse order to correct the error. Note also that, in this embodiment, the referrer (116) may optionally exit the make referral process at any stage by “saving” a partly completed referral without completing it.

A partly completed referral may be saved by actuating the submit referral button 272 shown in FIG. 13, which will initiate the validation procedure. The validation procedure will present the user with the option to save the referral as a draft referral or as a completed referral and if the user selects the draft referral option, a draft flag will be set in a status field (314) of the referral record data structure 276 so that searches of the records in the database 130 can distinguish between draft referrals and complete referrals. To retrieve draft referrals for later completion, actuation of the draft referrals button (202 in FIG. 3) causes the host processor to search the database to obtain a list of draft referrals and to facilitate the user selecting a draft referral for editing, in which case the information already entered from the draft referral is copied into a blank data structure used for a new referral and the user can navigate through the make referral pages described above to add information, as appropriate.

Validation

If the user does not activate the save as draft function, a validation process is initiated to test the information entered by the user against one or more validation criteria. Validation criteria may include a default set of criteria established by administrators of the system, and/or custom criteria associated with the designated referee (118) for the referral (114), for example.

The validation process may involve checking whether all necessary information has been properly entered and whether the referral is a duplicate referral. A duplicate referral could arise if two different users accidentally tried to submit the same referral independently, or if the user forgot that the referral had been previously submitted. The existence of a duplicate referral is detected by configuring the filter (160) to identify whether there are any other collections in the database (130) having the same referrer and referee for the same patient and the same problem, possibly within a particular past time period (e.g., 6 months). If at least one such collection is identified, a warning notification may be provided to the user with an option to cancel or proceed with the referral, for example.

The validation process may also involve checking whether the referral is appropriate for the particular consulting physician designated as the referee. The appropriateness of a referral may be tested according to the specialty and/or the preferences associated with the consulting physician in the database (130). In this regard, each consulting/referee physician is associated with a list of conditions or problems that that consulting/referee physician will or will not treat, in order to limit unwelcome or inappropriate referrals. The client interface (162) facilitates allowing a referee to specify a list of specialities or practice areas for which it is appropriate to send referrals to this referee, thereby specifying conditions, problems, or needs that he or she will, and/or will not, address.

Waitlist Priority

In some embodiments, submitted referrals may automatically be prioritized onto a waitlist of the referee (118) in accordance with predefined problem prioritization rules, which may be stored in the database (130) of the server (102). Automatic prioritization of incoming referrals in this way enables the referee (118) to filter or sort incoming referrals by waitlist priority by configuring the filter (160) to select or sort collections 274 by the contents of their WaitlistPriority field 320, for example. Sorting referrals in this way may be particularly useful for consulting physicians who need to manage their waitlist so as to address more serious medical problems sooner. The predefined problem prioritization rules used to classify incoming referrals may associate a particular waitlist priority with a particular problem or procedure indicated in the information submitted by the referrer (116). Prioritizing a referral may thus include reading a collection 274 for information units representing a problem or procedure in respect of which the referral was submitted (e.g., reading the ProblemID field 312 of referral record 276), searching the database 130 to determine a priority associated with that problem or procedure according to relevant prioritization rules stored in the database, and associating a particular priority status with the referral according to the relevant prioritization rule, by storing a priority status value in the Waitlist Priority field 320. One of four waitlist priorities such as “emergent”, “urgent”, “expedient”, and “routine” may be used, for example. The server (102), upon receiving a referral submission, may automatically classify a corresponding collection as having one of these four priorities, which effectively places the referral into a waitlist queue associated with that priority. In this embodiment, the consulting physician may rely on the default problem priority rules provided by the database 130 or may customize them to suit the consulting physician's preferences.

In this embodiment, third parties (e.g., insurers) pay the cost of a referral, whereas physicians decide if it is medically necessary. Thus, when a referral is submitted by the referee (116), the host processor may send a notification to a payer indicated by the Payer field 336 to facilitate pre-approval of payment to the referee (118). Alternatively, upon receiving a notification from the referee (118) that the referral is complete, the host processor may facilitate the referrer (116) notifying the payer that the referee (118) should be paid.

After the referral has been validated, the server 102 is directed to send or store all the information units pertaining to the referral, to or at the database 130. These information units are linked as a collection 274 representing the referral. The preparation of an electronic referral is thus completed.

Once a plurality of referrals have been made and stored as collections of information units as described above, various actions may be taken to treat the referrals (more precisely, the corresponding collections) as groups for display purposes. Actions may be taken to facilitate viewing and modifying of the referrals, and more particularly, the information units associated with the collections used to represent them, in response to user input. In this regard, the filter 160 shown in FIG. 2 facilitates grouping for display purposes.

Filter

As mentioned above, each client computer 104 or 106 in FIG. 2, is operatively coupled through a respective client interface 162 to a respective filter 160 at the server 102. In response to signals received at the client interface 162 from a client computer, the filter 160 is operable to cause the database interface 158 to identify collections of information units in the database 130 that satisfy a criterion, for example, by performing a search of the database for such collections, or by referencing a file, pointer or data stream indicating the identity of such collections. The filter 160 is further operable to cooperate with the client interface 162 to cause identifications to be displayed to a user at the client computer such that respective identifications correspond to respective collections of information units identified by the filter as satisfying the criterion. Displayed identifications, in effect, identify the group of collections satisfying the criterion, to the user.

In this embodiment, causing identifications to be displayed may involve causing labels corresponding to collections satisfying the criterion, to be displayed at the client computer. A label may comprise representations of one or more particular information units from the corresponding collection, displayed using a first set of display parameters. For example, as illustrated in FIG. 15, the client computer could be caused to display a label 352 comprised of particular information units from each corresponding collection of the group of collections identified by the filter 160. Each respective label may be shown as a respective line including a respective referral submission date, client name, a client identifier (e.g., personal health number), a client date of birth, a problem/need, an urgency status of the problem/need, a referral or waitlist status, a referrer name, and the referee name, and an indication of whether the client has been contacted or not, for example.

Referring back to FIG. 2, the filter 160 is further operable to use, as its filter criterion, a compound criterion comprising a plurality of sub-criteria, for example, a first criterion and one or more additional criteria. For example, a user could opt to view only identifications of incoming referrals from a desired referrer. To accomplish this, the client computer may be configured to receive user input indicating a desire to seek incoming referrals from the desired referrer and pass such input to the filter 160 to cause it to select from the database collections, having a ToID field 290 identifying the user (i.e., a first sub-criterion), and a FromID field 292 identifying the desired referrer (i.e., a second subcriterion). A set of identifications corresponding to the selected collections could then be caused to be displayed at the client computer in a manner analogous to that illustrated in FIG. 14.

It will be appreciated that the user interface provided by the client interface 162 may use mnemonic input elements to facilitate the user controlling the filter 160. In the above case, for example, the client interface 162 may allow the user to select the desired referrer's name from a list, and then it may map the selected name to a corresponding referrer identifier to be used to search the FromID field 292. Thus, while it may be impractical for the user to remember the desired referrer's identifier, the user can readily use a mnemonic input element associated with the referrer's identifier, to effectively select the desired referrer identifier.

Moreover, the client interface 162 may be operable to use a plurality of display criteria when causing identifications to be displayed, and these display criteria may correspond to respective sub-criteria of a collection identification criterion used by the filter 160. For example, the client interface 162 may cooperate with the filter 160 to cause labels associated with collections satisfying an additional selection criterion to be displayed at the client computer using a second set of display parameters, in order to distinguish labels associated with collections which satisfy the additional selection criterion from labels associated with collections that do not. The second set of display parameters may cause rendering of identifications satisfying the additional selection criteria in a different font, size or colour from surrounding identifications, displaying them in association with a graphic or animation, or the use of other distinguishing indicia. For example, in this embodiment, a new or modified but unread collection may have a blue blinking dot displayed adjacent a line of text identifying the unread collection. To take another example, an identification may be rendered in a bold font, thus distinguishing it from the other identifications which are rendered in a normal font.

The client interface 162 may automatically cause the filter 160 to use a predefined criterion as its criterion for searching, or it may solicit a user at a client computer to supply the criterion to be used by the filter. The client interface 162 may also be operable to present a set of predefined criteria at the client computer to the user, and to solicit the user to select a predefined criterion from among the presented set. In this embodiment, this is accomplished by the client interface 162 providing to a user at a client computer, a set of selectable input elements such as hyperlinks or buttons corresponding respectively to the set of predefined criteria. When the user selects one of the aforesaid input elements, this causes a selection signal, indicating a selected predefined criterion corresponding to the selected input element, to be transmitted to the client interface 162, which, in turn, causes the filter 160 to use the selected predefined criterion as its search criterion.

Thus, the client interface 162 may be operable to cause the filter 160 to use, as its criterion, a predefined criterion selected from a set of predefined criteria, in response to a selection signal received from the client computer, indicating the predefined criterion.

Referring to FIG. 3, some exemplary predefined criteria and input elements of this embodiment are explained in connection with the executive summary 180. The opening page shown in FIG. 3, may have embedded within it, code that automatically communicates with the filter 160 to cause it to scan the database 130 for new referrals for the current user, new messages, etc. The filter performs these scans and returns a number such as shown at 354 indicating the number of records meeting the criteria. The executive summary 180 includes a set of buttons beside the numbers returned by the filter (160), which invoke corresponding code to signal to the server (102) to cause it to actuate the filter to retrieve a list of referrals corresponding to the labels. For example, there is provided a “New Referrals” button 356 for causing the filter (160) to identify unread collections (i.e., new incoming referrals) addressed to the user. There is also a “Patients to be Contacted” button 358 for causing the filter (160) to identify collections for which the user is acting either as a referrer or as a referee and for which the patient has not yet been notified of the latest changes to the referral status. There is also a “Today's Appointments” button 360 operable to cause the filter (160) to identify collections for which the user is designated as referee of the referral and which have appointments set for today, a “Patient with Appointments” button 362, a “Patients on Waitlist” button 364; an “Updated Referrals—Incoming” button 366 and an “Updated Referrals—Outgoing” button 313.

In addition, it will be appreciated that buttons 184, 186, 188, 190, 198, 200, 202 and 204 of the main menu 178 are similarly associated with respective predefined criteria for use by the filter (160) to identify and display a set of collections to the user.

Referring to FIG. 2, it will be appreciated that at least some of the predefined criteria provided to the filter 160 in response to actuation of any button may be automatically established based on the identity of the user associated with a client computer, as identified by the authentication facility 164 when a session is established. That is, a user identifier identifying the user (e.g., a referrer identifier identifying the referrer 116, or a referee identifier identifying the referee 118) may be used to derive a simple or compound predefined criterion (or predefined criteria) for use by the filter 160. The predefined criteria includes criteria which are considered likely to be useful to this user, such as criteria identifying various types of collections associated with the user. Thus, the predefined criteria provided for selection to the referrer 116 or referee 118 may cause the filter 160 to identify collections having either the referrer identifier or the referee identifier in either the “FromID” field 292 or the “ToID” field 290, for example.

The filter 160 is further operable to cause identifications to be displayed at the client computer in an order dependent upon an information unit in each collection corresponding to a displayed identification. For example, the filter 160 may be configured to cause display of a given set of identifications in chronological order or reverse chronological order. The sort key used by the filter 160 may be controllable by the user of the client computer, such as by selecting a desired sort key from several options in a drop-down list box, e.g., 372 in FIG. 15.

The filter 160 may be operable to test various information units of respective collections as part of its criterion. In this embodiment, the filter 160 is further operable to establish its criterion based on the state or value of the referral status flag field 314 in the collection 274 shown in FIG. 14. Thus, the criterion used by the filter 160 may include a condition that the referral status flag (314) of a collection satisfies a referral status criterion, in which case the filter will identify collections having a referral status flag satisfying the referral status criterion. For example, the referral status criterion may be that a collection has a referral status flag (314) indicating that the collection has not yet been selected for viewing from the referee computer 106 (i.e., having an “unread” status).

Referring to FIGS. 2 and 14, testing a flag may be part of a compound criterion. For example, the referrer 116 may wish to identify collections sent by the referrer to the referee 118 that the referee has not yet viewed by selecting them from the referee computer 106. This may be accomplished in this embodiment by the referee 118 controlling the client interface 162, from the referee computer 106, to cause the filter 160 to identify collections having a “FromID” field 292 matching the referrer identifier, a “ToID” field 290 matching the referee identifier, and also having a referral status flag indicating that a collection is unread.

In this embodiment the filter 160 may also be operable to establish its criterion based on the state or value of the modification flag as represented by the ToStatusChanged and FromStatusChanged fields 298, 300 in FIG. 14. Thus, the filter 160 may be operable to identify collections having a modification flag satisfying a modification criterion so that identifications corresponding to collections having information units that have been modified in accordance with the modification criterion, are caused to be displayed at a client computer. For example, the filter criterion may be that a collection has a modification flag indicating that the referral associated with that collection has been cancelled. A modification flag may also be used as part of a compound criterion. For example, the referee 118 may wish to identify collections sent from the referrer 116 to the referee that the referee has cancelled. This may be accomplished in this embodiment by the referee 118 controlling the client interface 162, from the referee computer 106, to cause the filter 160 to identify collections having a “FromID” field 292 matching the referrer identifier, a “ToID” field 290 matching the referee identifier, and also having a FromStatusChanged field 300 indicating that the referral has been cancelled by the referee 118.

Thus, it will be appreciated that the referrer 116 and referee 118 may set the filter 160, from their respective client computers, to various settings throughout a session, to manage referrals in this system.

Information Display and Modification Facilities

Referring to FIG. 2, as stated earlier, the client interface 162 includes an information display facility 167 and an information modification facility 168 for remote viewing and modifying of collections. Both facilities 167, 168 are operable to be remotely controlled in response to control signals received from a client computer such as 104 or 106. In response to the control signals, the information display facility 167 is operable to facilitate viewing, from the client computer, of at least one information unit in a collection identified by the filter 160 and selected from the client computer by user input thereat. Similarly, in response to the control signals produced by a client computer, the information modification facility 168 is operable to facilitate causing a modification, from the client computer, of at least one information unit in a collection identified by the filter 160 and selected from the client computer by user input thereat.

As described above, the filter 160 is used to identify a set of collections in the database 130 meeting filter criteria established by default in response to user actions and/or by direct input of criteria by the user. In response, a set of identifications respectively corresponding to the set of collections is displayed at the users client computer. A user may select a particular collection from the set for viewing. In particular, the client interface 162 is operable to receive, from the client computer, a selection signal indicating selection by the user of a particular collection from among the set of collections identified by the filter 160. In this embodiment, the selection signal may be generated when the user clicks on a hyperlink embedded in a displayed identification, thereby effectively selecting the collection that it represents. The information display facility 167 causes display at the client computer of information units from the selected collection, in response to the selection signal.

Referring to FIGS. 2 and 14, the collection 274 described above as having been created by the referrer 116 from the referrer computer 104, and being addressed to the referee 118 at the referee computer 106, may be identified by the filter 160 and selected by a user operating either the referrer or referee computers 104, 106. In response to selection signals from either the referrer or referee computer 104, 106 the client interface 162 causes the information display facility 167 to cause at least one information unit in this collection 274 to be displayed at the particular computer or computers 104, 106 from which the selection signal was received. Similarly, information units of this collection 274 may be remotely modified from either computer 104, 106 using the information modification facility 168. Once the information display facility 167 causes display of information units from a selected collection 274 to a user at a client computer in response to a selection signal identifying the selected collection, the information display facility 167 then presents a set of modification options, relating to the collection, to the user, the modification options being selectable and controllable through corresponding input elements (e.g., hyperlinks, buttons, text input boxes, and other suitable input elements). If the user selects one of these modification options, this is interpreted by the information modification facility 168 as the issuance of a modification command. The information modification facility 168 thus facilitates the user modifying at least some information units of the collection 274 in accordance with the modification command issued. In response to issuing a modification command, the information modification facility 168 may prompt the user for user input providing the details of the desired modification. For example, if the user issues a command to modify the notes associated with the referral 114, the user may be prompted to enter additional notes, which are appended to the Referral Notes field 302 of the corresponding collection 274 as the command is executed, Modifications may relate to modifying the data content of the collection 274 or flags associated with the collection, for example.

Effectively, this collection 274 is accessible in this embodiment through both the referrer and referee computers 104, 106 for both viewing and modifying, since both the referrer 116 and referee 118 are parties to the referral 114. The ability to both view and modify a collection representing a referral 114, from respective computers associated with the referrer 116 and the referee 118, provides a flexible vehicle for ongoing, interactive communication between the referrer 116 and referee 118 of information pertaining to the referral 114.

Incoming Referrals/Outgoing Referrals

Referring back to FIG. 3, in this embodiment, the system 100 facilitates management of referrals by providing a virtual inbox and outbox for incoming and outgoing referrals, respectively. Specifically, “Incoming Referrals” and “Outgoing Referrals” buttons 184 and 186 are operable to send signals to the server 102 to invoke blocks of program codes that cause the server 102 to cause representations of incoming or outgoing referrals (as appropriate) to be displayed at the client computer (e.g., in the web browser 142).

Referring to FIGS. 3 and 14, on receiving a signal from the client computer in response to actuation of the incoming referral button 184, for example, the filter (160) is loaded with filter criteria specifying that all collections having the current user identifier in the ToID field 290 are to be located and sorted according to the contents of the urgency field 304. The filter (160) returns to the display facility (167) a list of records satisfying the above criteria and sorted as specified. The display facility (167) provides at the client computer a selectable list of identifications corresponding to incoming referrals, as shown at 500 at FIG. 15. The display interface hyperlinks the identifications to actual records of corresponding collections in the database (130) so that the user can simply click on an identification of interest to see details of the associated referral.

The page shown in FIG. 15 includes input elements 370, 372 and 374 which may be used to receive user input to cause the filter (160) and client interface (162) to change the list of identifications seen in FIG. 15 according to user-specified criteria. In this embodiment, the user may control the filter (160) to view only identifications corresponding to referrals meeting a predefined criterion, such as only new referrals, unread referrals, referrals where the patient has been contacted, updated referrals, referrals to a particular physician, patients on the wait list, patients with appointments, or only pending referrals, for example. Drop down boxes in input elements 370 and 372 can be used to give the user the ability to filter and sort database records based on criteria associated with any suitable field in the referral record data structure 276 shown in FIG. 14.

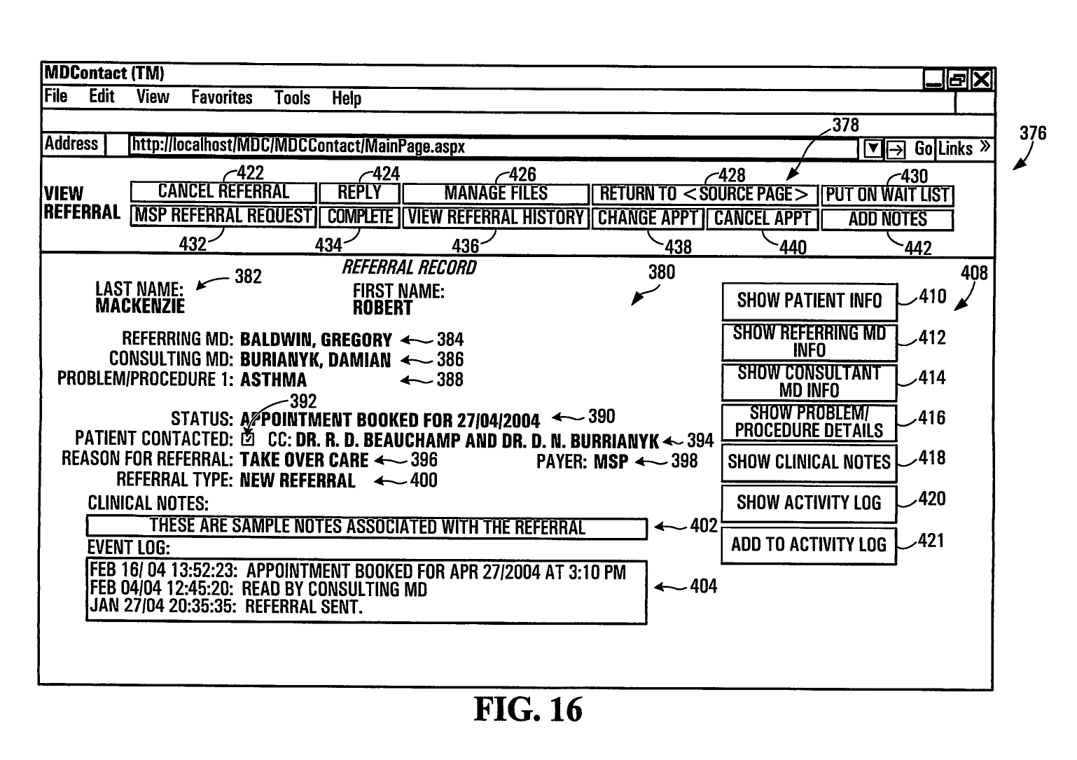

When the user actuates a hyperlink associated with one of the labels seen in the list of identifications displayed in FIG. 15, a signal is sent to the server (102) causing it to produce and send to the client computer a dynamic web page to produce a display as shown at 376 in FIG. 16 at the client computer, to reveal the contents of a selected referral record. This display is caused by the information display facility 167 of the server 102.

Referring to FIG. 16, a display produced by an dynamic web page for displaying the contents of a user-selected referral collection is shown generally at 376. The display includes a referral menu bar, shown generally at 378, and an information area, shown generally at 380. In the embodiment shown, the information area includes information from the user-selected collection, shown as bold text. This text is obtained from corresponding fields in the collection 274 shown in FIG. 14, for example. The information shown in this embodiment includes the patient name 382, the referring physician name 384, the consulting/referee physician name 386, the problem or need 388, the referral status 390, an indication of whether the patient was contacted regarding the latest change to the status of their referral 392, an indication of to whom a carbon copy of the referral was sent 394, the reason for the referral, the payer for the referral 398, the referral type 400, clinical notes 402, and an event log 404.

In the specific collection shown in FIG. 16, the referring physician is “Gregory Baldwin”, as shown at 384, the referee 118, or consulting physician, is “Damian Burianyk”, as shown at 386, and the patient is “Robert MacKenzie”, as shown at 382. Since this view was generated in response to selecting a hyperlink 352 in an “Incoming Referrals” display (FIG. 15), it should be evident that the display of FIG. 16 would have been presented at a computer associated with the referee “Damian Burianyk” or by an authorized agent of this referee (e.g., an associated MOA).

An “Event Log” display area 404 shows only three entries in reverse chronological order:
(a) a first entry for Jan. 27, 2004, when the referral was first created by the referrer 116 by using the referral creation facility 166;
(b) a second entry for Feb. 04, 2004, when the referral was first read by the referee 118 via the information display facility 167; and
(c) a third entry for Feb. 16, 2004, when the referee 118 set an appointment using the information modification facility 168.

The information area 380 further includes its own menu area, shown generally at 408, including the following buttons: show patient info 410, show referring MD info 412, show consultant MD info 414, show problem/procedure details 416, show clinical notes 418, show activity log 420, and add to activity log 421. The show patient info button 410 invokes code within the dynamic web page that causes the server 102 to send to the client computer a new dynamic web page similar to that shown in FIG. 16, with further information pertaining to the patient from the collection 274, or from another patient database that may be accessible to the system. The “show referring MD” button 412 invokes code within the dynamic web page that sends signals to the server 102 that cause it to send to the client computer a new dynamic web page (not shown) similar to that shown in FIG. 5, with further information pertaining to the MD from the collection 274, or from another MD database that may be accessible to the system. The show consultant MD info button 414 may do the same to cause a display of information similar to that shown in FIG. 9 pertaining to the consultant MD. The show problem/procedure details button 416 invokes code within the dynamic web page that causes the server (102) to send to the client computer a new dynamic web page, similar to that shown in FIG. 11, with further information pertaining to the medical problem from a medical problem database that may be accessible to the system.

At least some clinical notes from the notes field (302) are displayed to the user in a notes display area, as shown generally at 402. While this display area may be made larger than illustrated in FIG. 16, it may be desirable to display more information from the notes field (302) than can be conveniently displayed in this display area. Accordingly, the show clinical notes button 418 invokes code within the dynamic web page that causes a window to open and which causes the server (102) to send to the client computer a dynamic web page similar to that shown in FIG. 12 to enable access to any further information stored in the notes field (302) or files associated therewith.

At least some entries stored in the activity log field (330) are displayed to the user in the event log display area shown generally at 404. The show activity log button 420 invokes code within the dynamic web page that causes a window to open in the current page to display any further information stored in the activity log field (330) of the record (276).

The add to activity log button 421 invokes code within the dynamic web page that enables a user to add a free-form text entry to the activity log field (330). The user may enter a note, for example, indicating that attempts have been made to contact the patient but that to date, no contact has been made. A chronological order indicator (e.g., date and time) and an identification of the user may automatically be associated with the entry in order to indicate who made which entry, and when.

Still referring to FIG. 16, operations of the referral menu bar 378 will now be described.

The referral menu bar 378 includes a plurality of buttons that invoke code in the current dynamic web page, to cause corresponding processes to occur at the server (102). In the embodiment shown, the referral menu bar 378 includes a cancel referral button 422, a reply button 424, a manage files button 426, a return to source page button 428, a put on wait list button 430, a medical services plan (MSP) referral request button 432, a complete button 434, a view referral history button 436, a change appointment button 438, a cancel appointment button 440 and an add notes button 442.

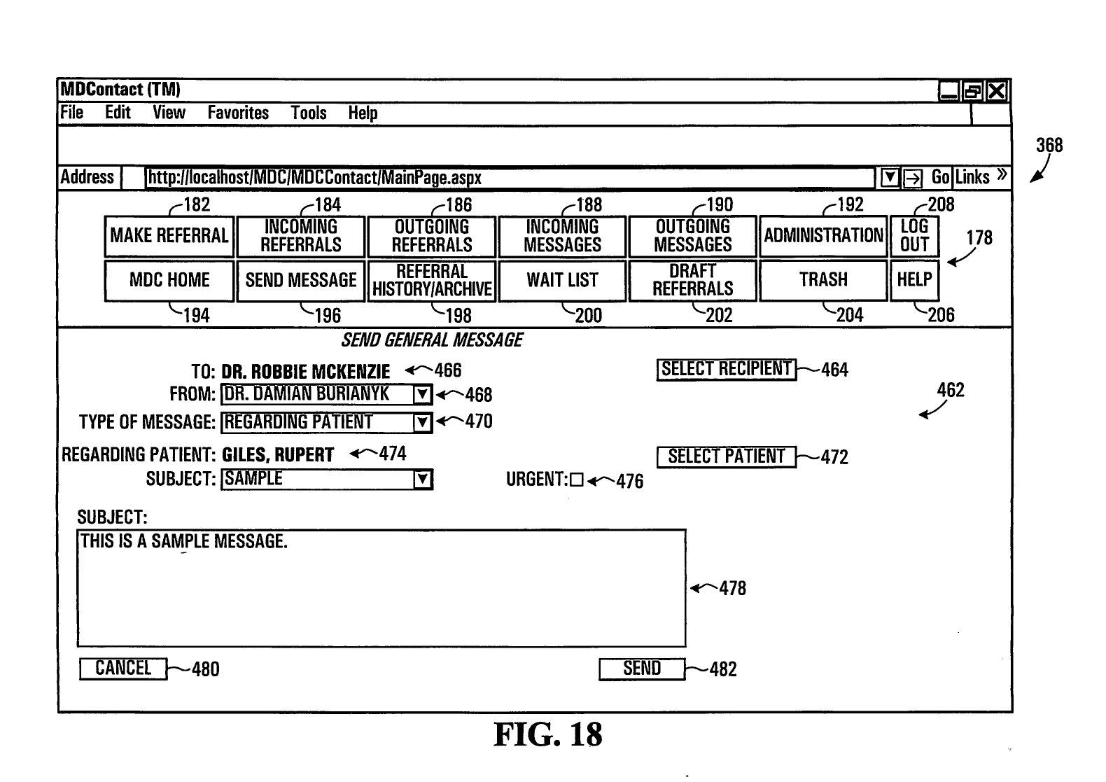

Actuation of the cancel referral 422 button invokes code that causes the client computer to send the server (102) a cancellation signal to indicate that the referral should be cancelled. When either party to the referral cancels a referral, the contents of the status field (314) of the corresponding referral collection (274) are replaced with a cancelled status indicator, and the client interface (162) may automatically generate a cancellation message to the other party, similar to that shown in FIG. 18, indicating that the referral was cancelled and why.

In response to actuation of the reply button 424, a signal is sent from the client computer to the server (102) causing the server to produce and send to the client computer an dynamic web page for sending a message to the other party to the referral, such as is shown at 368 in FIG. 18.

Referring back to FIG. 16, in response to actuation of the manage files button 426, code is invoked at the client computer to send a signal to the server (102) to cause it to cause a window to open at the client computer and to list within that window the names of any files indicated in the attached files field (342) of the collection (274). The names of the files may be hyperlinked to the actual files enabling the user to simply click on one of the listed files for viewing.

In response to actuation of the view referral history button 436, code is invoked to cause the client computer to send a signal to the server (102) requesting a referral history/archive dynamic web page displaying a list of all referrals made for the patient indicated in the display area 380. The list may be shown in a format similar to that shown in FIG. 15, for example. To obtain the information required to populate this list, the filter (160) may be configured to identify collections for which the contents of the PatientID field (280) match the current patient's identifier (e.g., PHN) and for which the contents of the status field (314) indicate that the referral has been completed.

When a referral is completed, the user may actuate the MSP referral request button 432 to indicate that payment is now authorized to be made in connection with this referral by a third party payer identified by the payer field (336). The payer may be a health insurer, for example. The server (102) may be configured to automatically submit a payment request to the indicated payer in response to actuation of the MSP referral request button 432.

Actuation of either the change appointment button 438 or the cancel appointment button 440 invokes code at the client computer that sends a signal to the server (102) causing it to locate the contents of the appointment time field (324) to determine if and when an appointment has been scheduled with the consulting MD indicated in the ToID field 290 of the collection. If no appointment time has been previously entered into the appointment time field (324), a dynamic web page (not shown) containing a blank template for doing so is presented at the client computer. If an appointment time has been previously entered into the appointment time field (324), a template is provided to facilitate changes to the appointment time. The template may provide a list of times with certain time blocked out, to indicate that appointments have already been booked in those times, to permit persons scheduling appointment times to avoid selecting a contentious appointment time.

Of course, to maximize the benefit of making appointments with this system, it may be desirable that the system include provisions for managing all appointments, not just those that relate to referrals. In this regard a suitable interface between Microsoft Outlook™, for example, and the appointment time fields of collections may be desirable.

Actuation of the “put on waitlist” button 430 by a consulting physician invokes code at the client computer that directs the client computer to send signals to the server (102) to cause the referral to be entered into a virtual waitlist associated with the consulting physician. The waitlist may be implemented as a file containing identifications of referral records having a “sent to id” field (288) identifying the physician with whom the waitlist is associated, and the collections associated with this file may be automatically sorted according to the contents of the waitlist status, priority and reason fields 320, 322 and 332, for example.

Actuation of the complete button 434 invokes code at the client computer that causes a signal to be sent to the server (102) to cause it to change the referral status field (314) of the present collection (274) to “complete” so that it may be treated differently than pending referrals by the filter (160). This button may appear on an dynamic web page intended for viewing by a consulting physician and desirably would not be made to appear on an dynamic web page intended for viewing by a referring physician.

Actuation of the add notes button 442 invokes codes for causing the client computer to send a signal to the server (102) to cause it to open a window in the currently displayed dynamic web page to facilitate the entry of notes which are then appended to the Notes field (302) associated with the collection (274).

Referral History/Archive

Referring back to FIG. 15, activation of the Referral History/Archive button 198 of the main menu 178 invokes blocks of codes at the client computer causing it to send a signal to the server (102) causing it to send back to the client computer a dynamic web page similar to that shown in FIG. 15. To do this, the filter (160) is loaded with filter criteria that employ the contents of the status field (314) to cause selectable identifications of archived (i.e., complete) referrals to be displayed. The user may then be presented with a plurality of options to narrow the filter criteria and sort the identifications using the user entry boxes 370 and 372 for example. In some embodiments, the dynamic web page may accept further user input specifying a specific patient in order to configure the filter (160) to identify referrals sent for that patient by employing the contents of the patient identifier field 280. Alternatively, or in addition, the dynamic web page may be operable to accept user input specifying a specific physician, in order to configure the filter (160) to identify cancelled or completed referrals for that physician. In the latter case, the filter (160) would be configured to identify collections based on the contents of the ToID, FromID and status fields (290, 292 and 314) as appropriate.

Various filter (160) criteria could also be used in combination based on any combination of appropriate information units of respective collections (274) in the database 130. For example, a user might control the filter (160) to cause the server (102) to show “Archived Referrals” for a specific patient or physician, with a date before Jan. 1, 1990.

Wait List

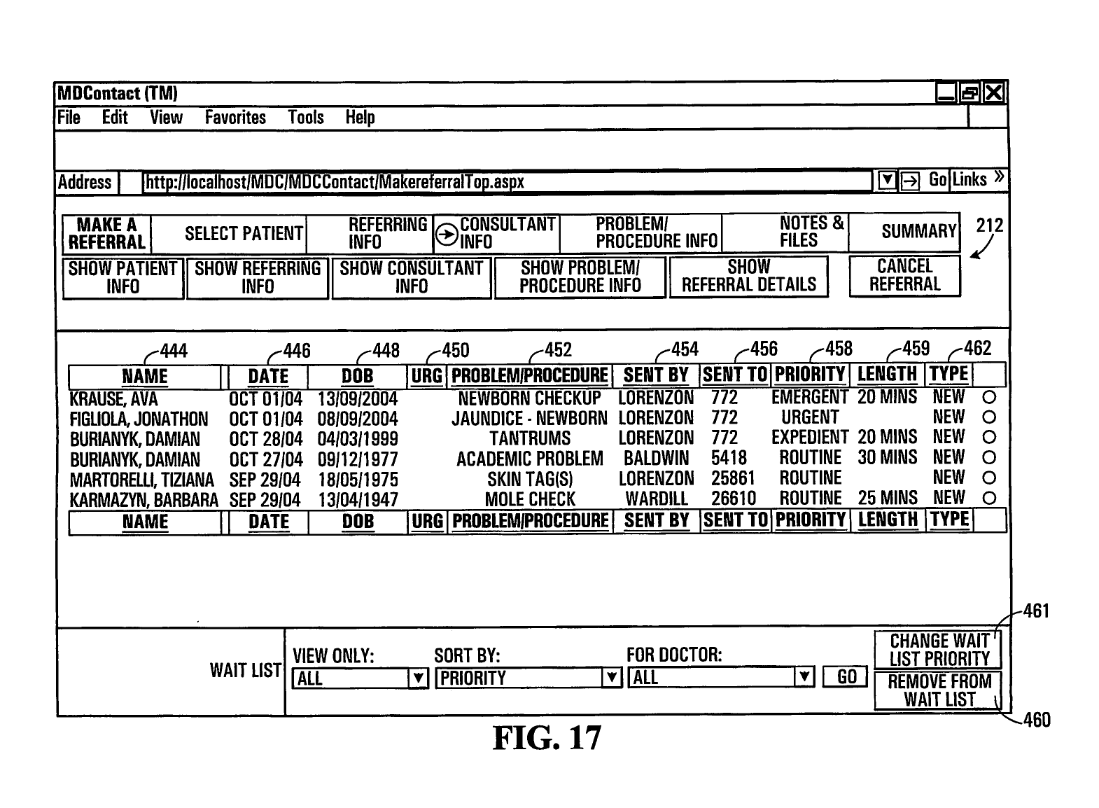

Referring back to FIGS. 3 and 15, when the user actuates the wait list button 200, blocks of code are executed by the client computer to cause a signal to be issued to the server (102) to cause the server to specify filter criteria to the filter (160) to cause it to seek records from the database (130) according to the contents of their waitlist priority field (320), wait list status field (322) and reason field (332). Records satisfying the specified criteria are identified and the client interface (162) causes a dynamic web page as shown in FIG. 17 to be sent to the client computer to list identification of referrals on a waitlist associated with the user. Each referral identification is hyperlinked to its corresponding referral collection (274).

In the embodiment shown, the identifications include patient name 444, date for which the referral was created 446, date of birth 448, an urgency field 450, a problem procedure field 452, a sent by field 454 a sent to field 456, a priority field 458, a length field 459 and a type field 462. Each of the fields, with the exception of the length field 459, are loaded with the contents of corresponding fields by the same names in the corresponding referral record (276). The contents of the length field 459 are derived from the identification indicated by the problem procedure field 452 or may be derived from appointment information.

The waitlist dynamic web page may include further buttons 460 and 461 and associated blocks of code that respectively direct the server (102) to remove a referral from the waitlist or change the priority of a referral on the waitlist. Execution of these blocks of code causes the server 102 to correspondingly modify the Waitlist Priority 320, Waitlist Status 322 and Waitlist Reason 332 fields, as well as the ToStatusChanged 298 and FromStatusChanged 300 fields of the collection (274) associated with the referral.

Message

Referring back to FIG. 2, as a further feature of the system, the client interface 162 may facilitate a user sending a message, for example, in association with making particular modifications to a collection 274. That is, in response to receiving particular modification commands from one of the referrer and referee computers 104, 106, the client interface 162 may facilitate the user sending a message from that computer to the other of said referrer and referee computers 106, 104. In this embodiment, for instance, when either the referrer 116 or referee 118 cancels a referral, he or she is prompted to enter information for a cancellation message (e.g., explaining the reason for the cancellation), and this message is sent to the other party. In addition, in this embodiment, when marking a collection 274 associated with a referral as having been completed, the referee 118 is prompted to enter information for a “referral complete” message, and this message is sent to the referee 118 as a consultation letter reporting the results of the referral.

Incoming Messages/Outgoing Messages

Referring back to FIG. 15, the incoming messages/ outgoing messages buttons 188 and 190 invoke code that provides integrated messaging to facilitate referral management. When a user actuates the buttons entitled “Incoming Messages” 188 or “Outgoing Messages” 190, this causes the server 102 to display representations of incoming or outgoing messages at the user's computer, in a list form, similar to the way in which conventional emails would be seen in an Inbox or Sent folder (i.e., outbox) in Microsoft Outlook™, for example. To generate a message, a message generation dynamic web page as shown in FIG. 18 may be sent to the client computer in response to completion or cancellation of a referral or in response to user activation of the send message button 196 on the main menu 178.

Referring to FIG. 18, the dynamic web page for creating a message may include the main menu 178 seen in FIG. 15 and further includes an input area shown generally at 462. The input area 462 includes a select recipient button 464 which provides a contact list of all doctors registered with the system. Provisions may be provided to facilitate entry into a particular point on the contact list simply by entering the first few letters of the desired recipient's last name, for example, and then conventional scrolling may be used to locate the desired doctor's name. Clicking on the desired doctor's name causes the name to be copied to a “to” field 466 of the input area 462. Similar provisions may be provided for identifying the person from whom the message is to be sent, with the additional provision that the user identifier of the person logged onto the system may be used to locate the name of the person in the database 130, and this name may be used as a default name in a “from” field 468 in the input area 462.

Provisions such as a drop down box 470 may be provided for identifying message types. Messages in this embodiment are generally one of six types:

General Message Type: a general message, not associated with a patient, between physicians (i.e., referrers and/or referees);

Patient-related Message: a message between physicians about a patient;

Cancellation Message: a message generated when either party cancels an electronic referral, indicating that the corresponding real-life referral was cancelled and why;

Referral Complete Message: a message indicating that the referral is complete and including a consultation letter having a written account of the referee's diagnosis, treatment, and recommendations, for example, as well as other results of the referral;

Missed Appointment Message: a message indicating that the patient has missed an appointment with the referee; and

Referral Request Message: a message requesting a financial transaction that needs to be completed to allow the referee to bill for the referral.

Provisions may also be provided as shown at 472 for entering the name of the patient into a patient display field 474. In addition, similar provisions may be provided for entering subject information, from a pre-defined list of possible subjects. The use of a pre-defined list ensures that similar matters have similar subject identifiers, which provides for consistency among messages and makes them easier to group, if desired. The input area 462 may further include an urgency field 476, in which a simple yes/no identifier may be entered. In addition, a free form text entry box as shown at 478 may be provided for entry of free form text indicating a subject.

The input area 462 may further include a cancel button 480, which automatically cancels the message, and a send button 482 which sends the message to the database 130 for later retrieval by the intended recipient.

Referring to FIG. 2, the user may interact with the client interface 162 as described above to generate messages manually. In other cases, messages are generated by the client interface 162 in response to specific system events, for example, when a referee 118 indicates that a referral is complete, or when either a referrer 116 or referee 118 cancels a referral.

Regardless of how a message is generated, a “message” is represented by a complex variable within the system, namely, by an instance of a message record, defined in accordance with a message data structure, as shown in Table 12 below. It will be appreciated that the message record is somewhat similar to the referral record 276, and thus many of the functions available in this embodiment in respect of collections 274, may also be made available in respect of messages. In this embodiment, a message record includes fields as follows:

TABLE 12
Message Record Data Structure

```
Date - date message sent
PHN - personal health number of patient (if any) in message
Name - name of patient (if any)
DOB - date of birth of patient (if any)
Urg - urgency of message
ToName - Name of receiver (physician)
ToID - billing number of consulting physician (unique)
FromID - billing number of referring physician (unique)
msgType - type of message
msgID - unique ID for message
ToStatusChanged - holds changes/updates notification for the
  Consulting MD
FromStatusChanged - holds changes/updates notification for the
  Referring MD
referralNotes - content of message
Subject - Subject of message
Status - status of message
PC - Patient contacted (boolean)
referralLog - activity log for message
CC[i] - billing number of i-th physician on cc list
AttachedFiles - boolean indicating whether there are files associated
  with message
IsArchived - boolean indicating whether message is active or in trash
```

When the user enters information into the user interface shown in FIG. 18, for example, temporary variables (not shown) in the memory (112) of the server (102) are created to hold the information submitted. When the user submits the message to the server (102) by clicking the Send button 482, this causes the server (102) to store the new message record in the database (130).

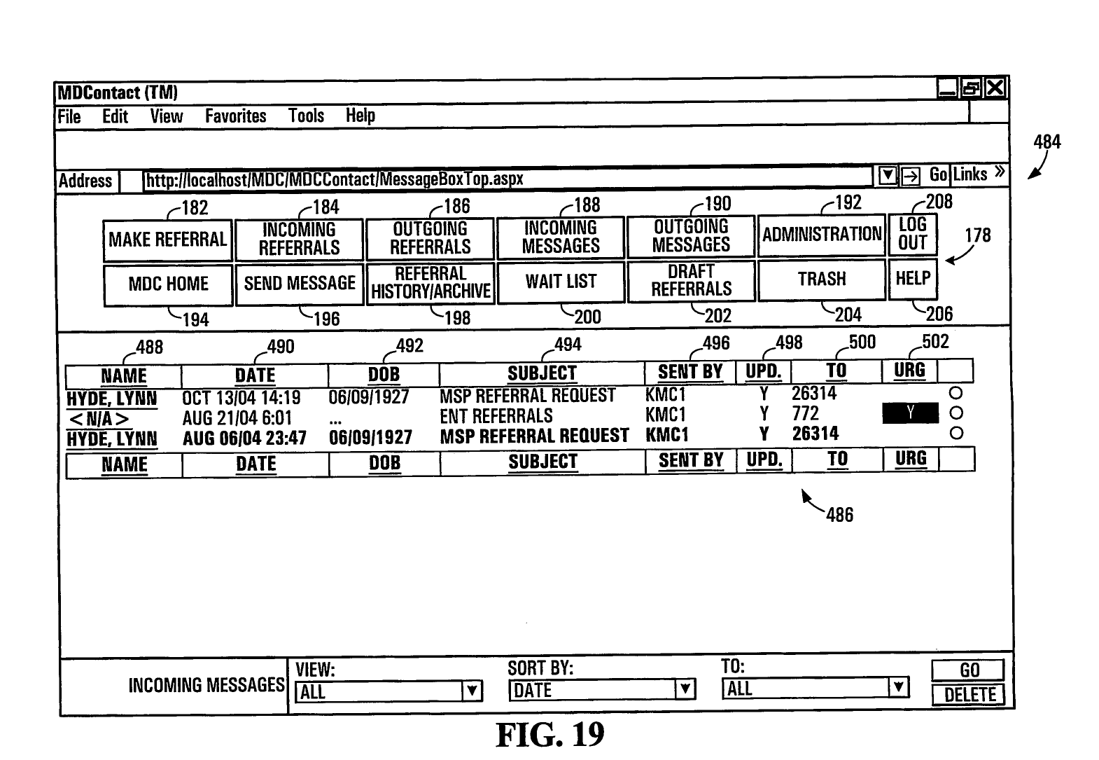

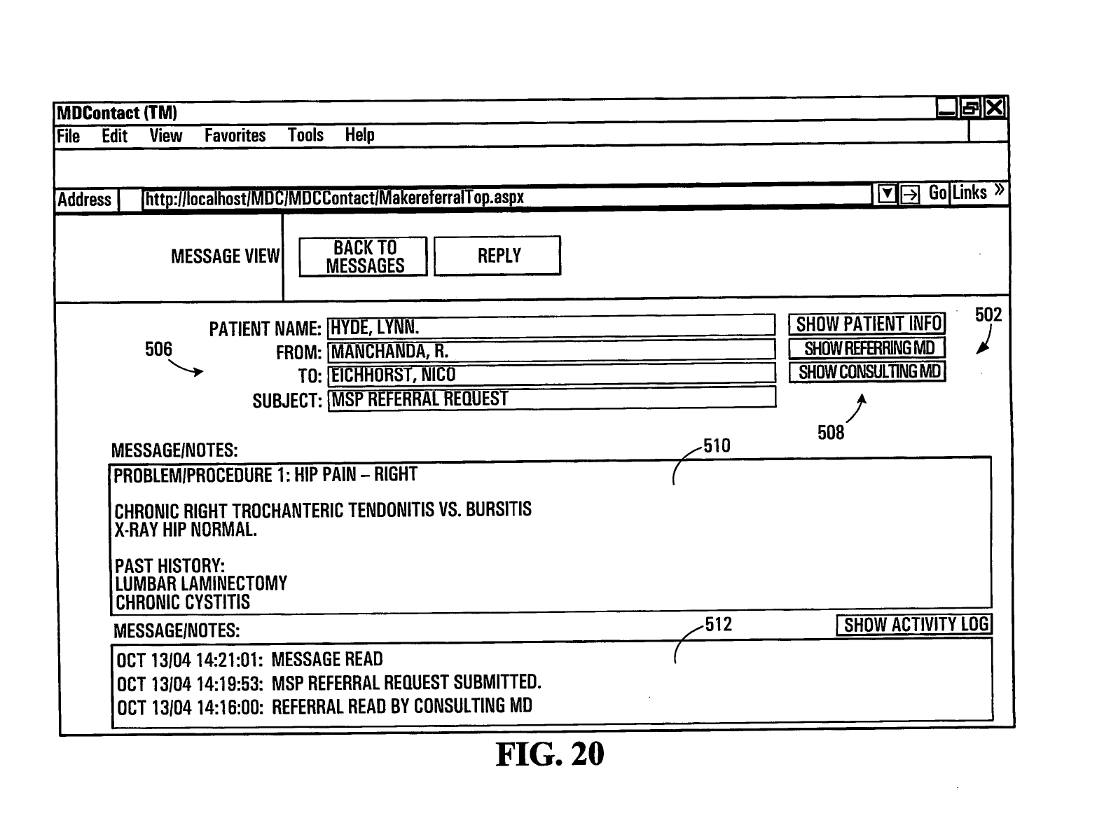

When the user actuates either the incoming messages button 188 or the outgoing messages button 190 code is invoked at the client computer to send a signal to the server (102) to cause it to send to the client computer a dynamic web page such as shown in FIG. 19, that provides a list of incoming or outgoing messages, respectively, at the client computer. Referring to FIG. 19, the dynamic web page that shows a list of incoming messages is shown generally at 484. The page includes a display area 486 having a name field 488, a date field 490, a date of birth field 492, a subject field 494, a sent by field 496, an update field 498, a to field 500, and an urgency field 502. The name field 488, date field 490, date of birth field 492, subject field 494 and urgency field 502 are extracted from corresponding fields from the same name of the record data structure 276 of the corresponding collection 274. The sent by field 496 is populated by indexing a look up table with the contents of the FromID field in the message record data structure. The update field 498 is populated with a yes or no depending upon the status of the ToStatusChanged field or the FromStatusChange field in the message record data structure (Table 12). The “To” field 500 likewise is populated by the contents of the ToID field of the message record data structure. As shown in the first entry in the name field 488, the patient name “HYDE, Lynn” is underlined to indicate that this identification is hyperlinked to the actual message record data structure for that patient. Actuation of such a hyperlink, directs the client computer to send a signal to the server computer 102 to cause it to send to the client computer a message view dynamic web page such as shown generally at 502 in FIG. 20.

Referring to FIG. 20, the message view dynamic web page 502 includes patient name, from, to, and subject information shown generally at 506, with buttons shown generally at 508 enabling expansion to show further patient information, further referring MD information, and further consulting MD information in dynamic web pages as shown in FIGS. 5, 6, and 7, for example. In addition, the message view page further includes a message/notes field 510 which includes notes entered in the subject field 478 in FIG. 18, by the originator of the message. The message view page further includes an activity log 512 indicating a date, time and user activity associated with the message.

Any new message text entered by a user will be appended to the message (in the ReferralNotes field shown in Table 12) and a modification flag associated with the message will be set (stored in the ToStatusChanged and FromStatusChanged fields shown in Table 12). When the party to whom the message is sent views his or her incoming messages, the client interface (162) will cooperate with the filter (160) and database interface (158) to identify messages which have been modified to the party. This may be accomplished by testing the ToStatusChanged or FromStatusChanged flags of Table 12 and varying the display parameters with which a representation of the modified message is displayed. A message sent by a user will always appear in that user's “outbox”, and a message received by a user will always appear in that user's “inbox”, even when it is modified (until it is deleted).

Administration

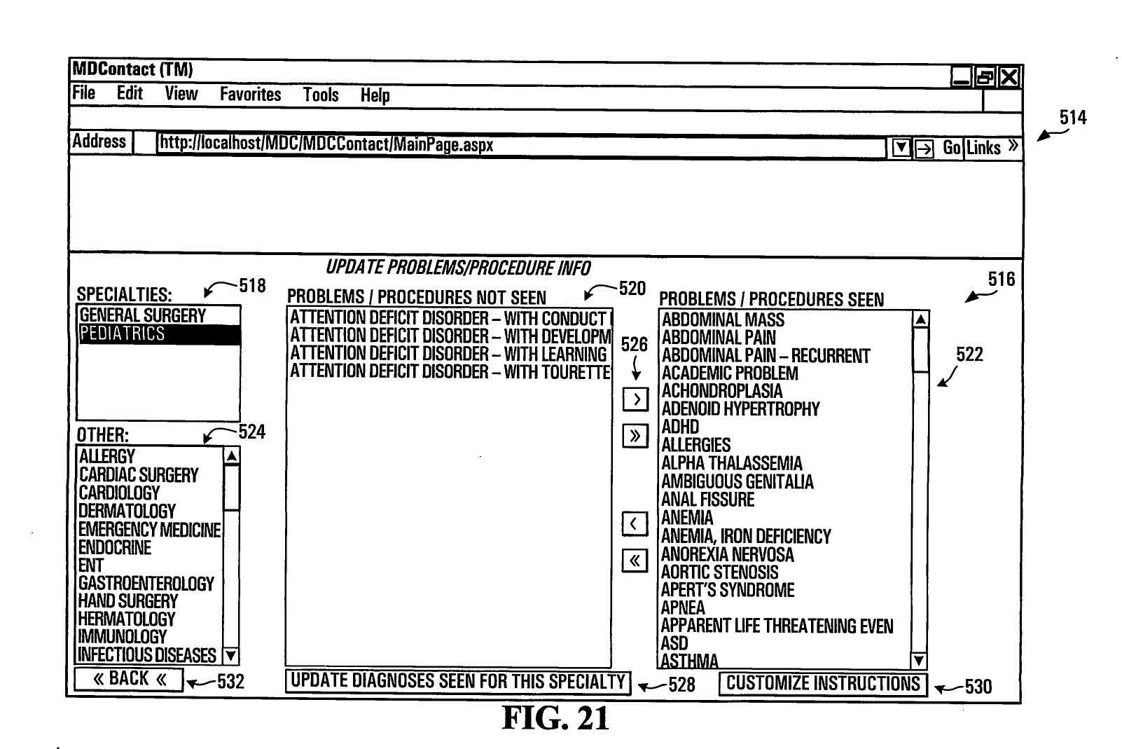

Referring now to FIG. 21, an “Update Conditions/Procedures Info” dynamic web page is displayed in a browser window 514 on the client computer (104, 106) as shown generally at 516.

The page includes a list 518 that displays a list of specialties which were associated with the user, shown to be “General Surgery” and “Pediatrics” in FIG. 21. The page also includes a list 520 that provides a list of additional specialties and practice areas that the user may add to the current list of specialties 518. Similarly, entries from list 518 may be removed by the user. The specialty practice information represented in list 518 may thus be changed by the user.

The server 102 associates each specialty or practice area with a list of needs, conditions or procedures that the user may choose to address or not to address, based on the user's specialization and/or preferences. A list of conditions 520 not seen or procedures not performed by the current user, and a list 522 of conditions seen or procedures performed by 522 the current user, are thus provided. By default, all problems and procedures for a specialty in the list 518 may be added to the “Problems/Procedures Seen” list 522, and all problems and procedures from the “Other” list 524 may be added to the “Problems/Procedures Not Seen” list 520. A user may choose a specialty from either list 518 or 524, which will cause the server 102 to display all the problems and procedures associated with that specialty in lists 520 and 522, respectively. The user may then cause the server 102 to move a selected problem or procedure from one list to the other (520 and 522) by using the four buttons shown generally at 526, and may cause the server 102 to update the “Problems/Procedures Not Seen List” 520 by actuating the button entitled “Update Diagnoses Seen For This Specialty” 528. Thus, the lists 520 and 522 may be updated by the use of the four buttons 526 and by the button 528, and the results may be stored in the database 130 in association with a user identifier associated with the user whose profile was customized.

In this fashion, a referee (e.g., a consulting physician) can customize the types of referrals that he or she is willing to accept. The referee's customized preferences may be enforced by the validation procedure described above in connection with the submission of a referral.

The dynamic web page 516 also provides a button entitled “Customize Instructions” 530, which facilitates a physician selecting a problem/procedure from list 522 and clicking button 530 to customize the instructions for that problem/procedure. Selecting button 530 allows the consulting physician to update the instructions which the referral creation facility (166) provides to the referring physician and/or to the patient, in respect of a particular condition or procedure. Default instructions may be stored for each condition/procedure in the server database (130), therefore the consulting physician need not customize the default instructions unless he or she is dissatisfied with them. If, however, the consulting physician chooses to customize at least some of the instructions, the customized instructions will be stored by the client interface (162) in the database (130) in association with an identifier identifying the consulting physician, to facilitate later retrieval. The user may click the “Back” button 532 to exit the “Update Problem/Procedure Info” screen and return to a page providing other administrative functions.

In general, the administrative features of the system 100 provide for patient and doctor information entry and further facilitate the following:
a. Updating the list of problems/needs seen or not seen by the user when acting as a referee (e.g., as a consulting physician), for use as a validation criterion by the referral creation facility 166 when a prospective referrer attempts to send an electronic referral to this user;
b. Customizing referrer and/or client (e.g., patient) instructions to be dispensed by the referral creation facility 166 whenever a referral concerning a particular problem/need is referred to the user;
c. Customizing a list of diagnostic questions to be presented by the referral creation facility 166 to a referrer as a referral relating to a particular problem/need is being created by the referrer;
d. Customizing an urgency level to be automatically associated with a particular referral problem/need by the referral creation facility 166, possibly based on answers to the aforesaid diagnostic questions;
e. Customizing automatic waitlist prioritization rules for classifying an incoming collection into a custom waitlist priority associated with this user based on the referral problem/need;
f. Customizing the procedures that must have been performed, or the information that must have been gathered, by a referrer before a referral for a particular problem or procedure will be accepted by this user; for example, a consulting physician could customize the medical tests required in order to accept a referral to treat a specific disease. Moreover, the medical tests required may vary based on responses to the diagnostic questions. These customized requirements may be used as a validation criterion by the referral creation facility 166 when an attempt is made to send a referral to this user;
g. Changing the user's status in the system 100, for example, designating that the user is out of the office, is not accepting new referrals, or is not accepting any referrals; and
h. Creating or changing a report template (e.g., a default form to be used for consultation letters upon completion of a referral).
   Exemplary Transactions

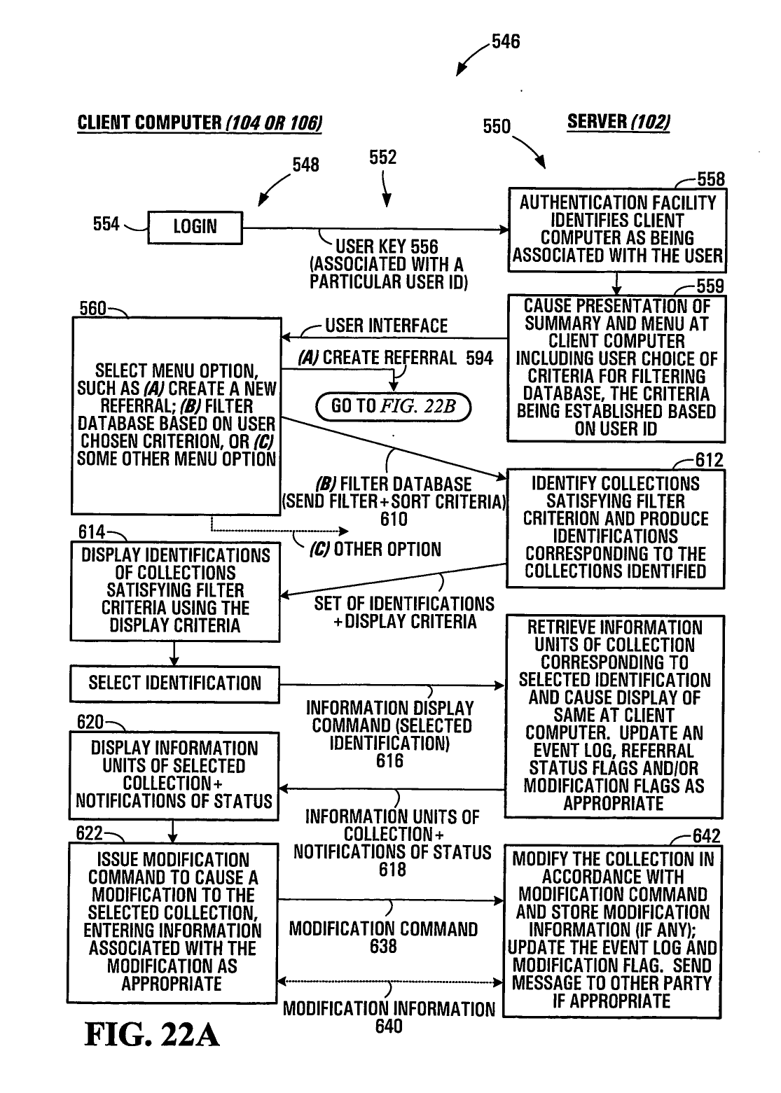

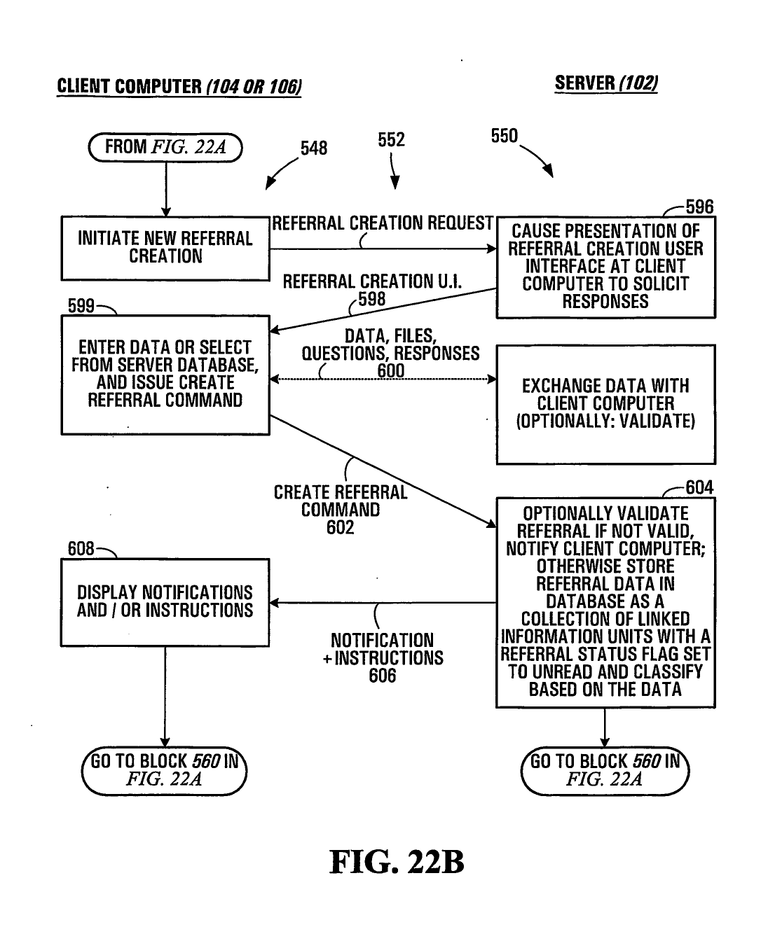

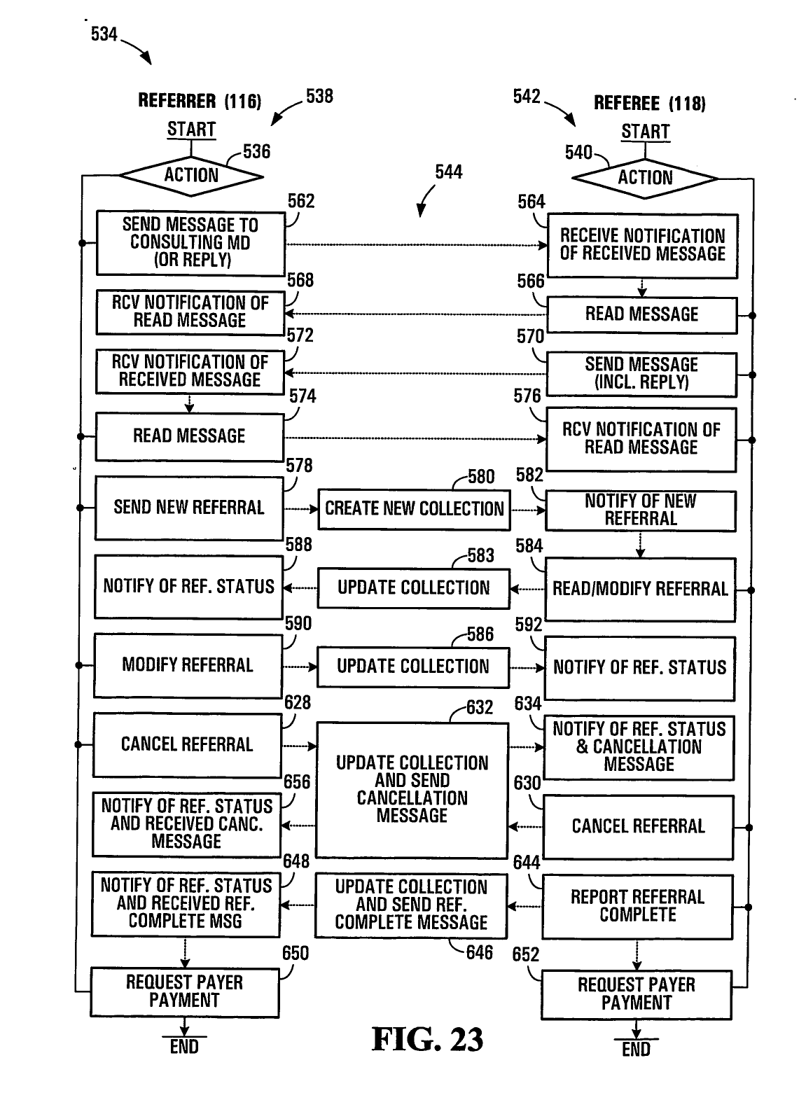

Referring back to FIG. 1, generally, the system 100 facilitates systematic and ongoing sharing of referral information between a referrer 116 and referee 118 by providing a workflow of predefined interactions between the parties 116, 118 through the server 102. Advantageously, the system 100 provides notifications to one party to a referral, of predefined transactions made in respect of the referral by another party to the referral. An overview of exemplary transactions of one embodiment will now be provided with particular reference to FIGS. 22A, 22B and 23.

FIG. 23 provides a high-level simplified communication flow diagram of several common interactions in this embodiment between the referrer 116 and referee 118, as shown generally at 534. Actions 536 or events associated with the referring physician are shown generally at 538, whereas actions 540 or events associated with the consulting physician are shown generally at 542. Communication signals and actions taken by the server (102) are represented by the middle section of FIG. 23, shown generally at 544.

FIGS. 22A and 22B provide a low-level flowchart illustrating an exemplary series of transactions between a client computer and the server (102) as shown generally at 546. The left hand column 548 represents actions taken by a client computer (104 or 106) while interacting over a network with the server (102), which is represented in the right hand column, shown generally at 550. Specific signals exchanged between the client computer (104, 106) and the server (102) are represented in the middle column, shown generally at 552.

Referring to FIGS. 22A and 22B, the referrer (116) and referee (118) must be pre-authorized to establish a session with the server (102) to use the system (100). A session with the server (102) begins when a user at a client computer (104 or 106) enters information into a login screen, as shown in block 554. In particular, the user enters a user key 556 associated with the user. The user key may be a user name and/or password. The user key 556 is received by the authentication facility (164) of the server (102), which ascertains whether the user key received corresponds to an authorized user of the system (100). If yes, at block 558, the authentication facility (164) identifies the client computer (104, 106) as being associated with a user identifier associated with the user key 556 and representing the user. At blocks 559 and 560, the server (102) causes a summary associated with the user to be presented at the client computer (104, 106) associated with the user. The summary may be as shown in FIG. 3, for example. Moreover, the user is presented with a choice of selectable predefined criteria for filtering the database (130), the criteria being established based on the user identifier and selection of buttons 184, 186, 200, 356, 358, etc., for example.

Referring to FIG. 23, block 562 illustrates the referrer 116 sending (or replying) to a message to (or from) the referee 118 using the “Send Message” menu option (196 in FIG. 3). When the message is sent, the server (102) will provide the referee 118 with a notification that a message was received, as shown at 564. The notification may involve the message appearing in a message inbox (i.e., “Incoming Messages”) of the recipient as shown in FIG. 19. When the referee 118 reads the message 566, the server (102) sends a notification to the referrer 116 as shown at block 568. This notification may involve the message being identified to the referrer as having been read (e.g., by being displayed with distinguishing indicia), based on a modification flag (as indicated by the ToStatusChanged and FromStatusChanged fields in Table 12) of a corresponding instance of a message data structure (e.g., message record) having been set. The above-described messaging steps also work analogously in the opposite direction as shown by blocks 570, 572, 574 and 576.

Block 578 in FIG. 23 illustrates the referee 116 invoking the referral creation facility (166) through button 182 in FIG. 3, to send a new referral to the referee 118. When the referrer 116 sends the new referral, this causes the server (102) to create a new collection (274), including a new referral record (276), and to add it to the database (130), as shown at block 580 in FIG. 23. As shown at block 582, the server (102) provides a notification to the referee 118 that a new referral has been received. As shown at block 584, when the referee 118 reads or modifies the referral, the referral collection 274 is updated accordingly as shown at block 583, and the referrer 116 is provided with notification of the update as shown at block 588. Similarly, the referrer 116 may modify the referral collection 274 as shown at block 590, causing the server (102) to update it accordingly as shown at block 586 and to notify the referee 118 of this modification as shown at block 592.

Referring to FIGS. 22A and 22B, creation of a referral is shown in greater detail. To create a referral, as shown at 594 and 548, actuation of the Make Referral button 182 in FIG. 3 sends a signal from the referrer computer 104 to the server 102 indicating that the referral creation facility (166) should be invoked. The referral creation facility (166) causes a user interface for referral creation to be presented to the referrer 116 at the referrer computer 104 to solicit responses from the referrer (as shown at 596, 598). The user interface for referral creation is represented by the dynamic web pages shown in FIGS. 4, 5, 6, 7, 8, 9, 10, 11 & 12, for example. In general, the referrer 116 enters or selects referral information pertaining to a referral in the user interface as shown at 599. Several iterations of data entry and interaction with the server 102 may be necessary as shown at 600. Specifically, several sets of data may be transmitted from the client computer 104 to the server 102. In turn, the server 102 may transmit one or more questions to be answered by the referrer 116 at the client computer 104, and the referrer's responses may be transmitted back to the server 102. The referrer 116 may also upload files to the server 102. The server 102 may test some of the data against validation criteria, and subsequent data or questions transmitted back to the referrer computer 104 may depend on whether the validation criteria were satisfied. Once the user is satisfied that all necessary data has been transmitted to the server 102, the user actuates the submit referral button 272 in FIG. 13 to issue a create referral command, as shown at 602, which is transmitted to the server 102. Additional validation criteria may be applied at this stage as shown at 604. If the validation criteria are not satisfied, the server 102 may generate warning notifications as shown at 606, 608 or may refuse to accept the referral. Otherwise, the referral creation facility (166) causes the information pertaining to the referral to be stored in the database (130) as a collection 274 of linked information units. In this embodiment, the referral status flag (314 in FIG. 14) is set to indicate that the collection (274) is as yet unread by the referee 118. The referral creation facility (166) may also cause instructions to be displayed to the referrer 116 for the referrer or for the patient, as shown at 606, 608.

Assuming the referee 118 also establishes a session from the referee computer 106, the referee will be notified in a user summary screen (e.g., as shown at 559 and in FIG. 3), that there is an additional new referral addressed to him or her. The referee 118 may then invoke a predefined filter criterion for identifying new referrals as shown at 610, which will cause the filter (160) to identify unread collections (274) in the database (130) which are addressed to the referee 118, as shown at 612. The server 102 will then display identifications of collections satisfying the filter criteria, to the referee 118, as shown at 614. If the referee 118 selects the identification of the aforesaid collection (274) created by the referrer 116, a selection signal is transmitted as shown at 616 to the server 102, whereupon the information display facility (167) causes display of information units from the selected collection at the referee computer 106, as shown at 618, 620. At the same time, the information display facility (167) updates the referral status flag (314 in FIG. 14) and activity log (330), to indicate that the selected referral was viewed from the referee computer 106.

The referee 118 may choose to respond to the new referral by setting an appointment date, for example. To accomplish this, the referee 118 uses the information modification facility (168) to modify an appointment status of the selected collection, as shown at 622. As shown at 642, this may involve exchanging modification information 640 with the server 102, such as data pertaining to an appointment time. When the referee 118 issues the modification command 638, this causes the information modification facility (168) to modify the collection (274) in accordance with the modification command. Moreover, the activity log (330) and appropriate flags associated with the collection (274) are updated to record the fact of this transaction. In this embodiment, the modification command is recorded in the modification flag (as represented by ToStatus Changed (298) and FromStatusChanged (300) fields) of the collection (274), and the modification information may be stored in these or other fields of the collection (274). If multiple modifications are made (e.g., an appointment is set, and referral notes are added), all these modifications may be stored as part of the collection (274) by modifying the appropriate fields.

When the referrer 116 accesses the system 100 again, the user summary (e.g., FIG. 3) seen by the referrer will display a notification that an additional outgoing referral was updated. The referrer 116 may then select a predefined filter option operable to identify updated outgoing referrals. As shown at 614, 616, 618 and 620, when the collection (274) at issue is identified to the referrer 116, the referrer may select its identification to cause the information display facility (167) to display the modifications made by the referee 118 in detail (e.g., an appointment was set, and the referee 118 may have also sent some specific notes with instructions). (Alternatively, some changes may be displayed as part of the identification itself.) Invoking the information display facility (167) will also update the activity log and reset the modification flag of the collection (274) to indicate that the referrer 116 is deemed to be aware of the modifications made by the referee 118 to the collection (274), and hence, of the progress of the real-life referral it represents.

Referring back to FIG. 23 as shown by blocks 628 and 630, either the referrer 116 or the referee 118 may cancel a referral. When this occurs, the server (102) updates the referral collection (274), as shown at block 632, and notifies the other party, as shown at blocks 634 and 656. In greater detail, referring to FIG. 22A, as shown at 622, 638, 640 and 642, the referrer 116 or referee 118 again engage in low-level interactions with the server 102. As before, a cancellation command causes a specific modification of the collection (274). In addition, in this embodiment, it involves sending a cancellation message to the other party, as shown at 642. Both the modification and the cancellation message are detectable by the other party by appropriately controlling 560 the filter (160), and may be viewed by controlling 616 the information display facility (167). The latter step causes the activity log (330 in FIG. 14) and various flags of the collection (274) to be updated or reset. In this manner, all parties to a referral can be informed of the progress of the referral, and detailed information about all significant transactions is accumulated.

Referring back to FIG. 23, when the referee 118 reports that a referral is complete, such as by actuating the “complete” button 434 shown in FIG. 16, for example, as shown at block 644, the referral collection (274) is updated accordingly, and a Referral Complete Message is sent to the referrer 116 as shown at blocks 646 and 648. (The low-level interactions with the server 102 are similar to those described above.) After a referral has been handled, the referrer 116 and referee 118 may submit a request via the server 102 for payment as shown at blocks 650 and 652.

While specific embodiments of the invention have been described and illustrated, such embodiments should be considered illustrative of the invention only and not as limiting the invention as construed in accordance with the accompanying claims.

What is claimed is:

1. A method of managing referrals from a referrer to a referee, the method comprising:
in response to a first set of signals received from a referrer computer, causing a database to store information pertaining to a referral from said referrer to said referee, as a collection of linked information units, said information units including a referrer identifier identifying said referrer as originator of said information and a referee identifier identifying said referee as intended recipient of said information, said collection representing said referral and being accessible by said referrer computer and by a referee computer;
in response to a second set of signals received from one of said referrer and referee computers, causing collections of information units that satisfy a criterion, to be identified and causing identifications of said collections to be displayed, at said one of said referrer and referee computers,
in response to a third set of signals received from said one of said referrer and referee computers, causing at least one information unit in a collection corresponding to a displayed identification, to be displayed at said one of said referrer and referee computers; and
in response to a fourth set of signals received from said one of said referrer and referee computers, causing at least one information unit in said collection corresponding to a displayed identification, to be modified.

2. The method of claim 1 wherein causing information to be stored comprises causing a referral status flag, representing a status of said referral to be stored, in an information unit of said collection, and causing said referral status flag to be set to a first value to indicate that the collection has not yet been viewed by the referee.

3. The method of claim 2 further comprising causing said referral status flag to be set to a second value if at least one information unit of said collection has been displayed at said referee computer.

4. The method of claim 2 wherein identifying collections comprises identifying collections having a referral status flag satisfying a referral status criterion.

5. The method of claim 1 further comprising (a) facilitating uploading of a file from one of said referrer and referee computers in response to upload signals received therefrom; (b) causing said file to be stored in association with a collection associated with both said referrer and said referee; and (c) facilitating downloading of said file to one of said referrer and referee computers in response to download signals received therefrom.

6. The method of claim 1 wherein identifying collections comprises establishing said criterion based on at least one of said referrer identifier and said referee identifier.

7. The method of claim 6 wherein establishing said criterion comprises causing said criterion to be set to a predefined criterion selected from a set of predefined criteria, in response to a selection signal, in said second set of signals, selecting said predefined criterion, each predefined criterion in said set being based on one of said referrer identifier and said referee identifier.

8. The method of claim 1 wherein identifying collections comprises identifying collections including at least one of said referrer identifier and said referee identifier.

9. The method of claim 1 wherein causing at least one information unit to be modified comprises causing a modification flag to be set in an information unit associated with said collection corresponding to a displayed identification.

10. The method of claim 9 wherein causing said modification flag to be set comprises causing a modification flag value to be stored as said modification flag to represent a modification command received in said fourth set of signals.

11. The method of claim 9 further comprising, if said collection corresponding to a displayed identification is caused to be displayed at one of said referrer and referee computers, causing said modification flag to be reset.

12. The method of claim 9 wherein identifying collections comprises identifying collections having a modification flag satisfying a modification criterion so that identifications corresponding to collections having information units that have been modified in accordance with said modification criterion, are displayed.

13. The method of claim 9 further comprising causing to be presented, a representation of said modification flag, at at least one of said referrer and said referee computers.

14. The method of claim 1 wherein causing identifications to be displayed comprises listing labels respectively associated with said collections to be shown in a display image.

15. The method of claim 14 wherein causing identifications to be displayed comprises using different display parameters for different labels to distinguish at least one label from another.

16. The method of claim 15 further comprising causing a set of display parameters associated with a selection criterion to be associated with labels of collections that satisfy said selection criterion.

17. The method of claim 1 wherein causing information to be stored comprises causing information including at least one of a client name or identifier, a client date of birth, a need, an urgency status associated with said need, a referrer name, and a referee name to be stored.

18. The method of claim 1 wherein causing information to be stored causing a class identifier classifying said referral into a pre-defined classification to be produced, in response to said first set of signals, and causing said class identifier to be stored in an information unit associated with said collection.

19. The method of claim 18 further comprising causing at least one question to be presented to an operator of said referrer computer, receiving a response to said at least one question, and causing said class identifier to be produced in response to said response to said at least one question.

20. The method of claim 18 wherein causing collections to be identified includes causing collections that have class identifiers satisfying a criterion to be identified.

21. The method of claim 1 further comprising causing at least one question to be presented to an operator of said referrer computer and receiving a response to said at least one question.

22. The method of claim 21 further comprising causing said response to said at least one question to be stored in information units associated with said collection.

23. The method of claim 21 further comprising causing a notification to be transmitted to said referrer computer when said response to said at least one question does not satisfy a validation criterion.

24. The method of claim 1 wherein causing identifications to be displayed comprises causing identifications to be displayed in an order dependent upon at least one information unit in each collection.

25. The method of claim 1 further comprising causing an event log to be associated with said collection and adding an entry to be added to said event log in response to occurrence of an event involving modification of at least one information unit of said collection in response to said fourth set of signals.

26. The method of claim 25 wherein causing an entry to be added said event log comprises causing a chronological order indicator to be associated with an identification of said event.

27. The method of claim 26 wherein said identification of said event includes an identification of said referrer or referee computer from which said fourth set of signals were received.

28. The method of claim 25 further comprising facilitating viewing of said event log from at least one of said referrer and said referee computers.

29. The method of claim 1 further comprising, in response to receiving said fourth set of signals from said one of said referrer and referee computers, causing a message to be sent to the other of said one of said referrer and said referee computers.

30. The method of claim 1 further comprising causing information units and computer readable codes to be transmitted from said database, to one of said referrer and referee computers, said computer-readable codes being operable to cause a processor circuit at said one of said referrer and referee computers,
(i) to cause at least some of the transmitted information to be displayed at said one of said referrer and referee computers; and
(ii) to facilitate generation, in response to user input at said one of said referrer and referee computers, of communication signals for transmission from said one of said referrer and referee computers, said communication signals including at least one of said first, second, third and fourth sets of signals.

31. The method of claim 30 wherein said computer-readable codes are interpretable by a markup language interpreter.

32. The method of claim 1 wherein said third set of signals includes a selection signal indicating selection of said collection corresponding to a displayed indication.

33. The method of claim 1 wherein said third and fourth sets of signals are the same.

34. The method of claim 1 wherein causing at least one information unit in said collection corresponding to a displayed indication to be modified comprises limiting which information units may be modified according to whether said fourth set of signals are received from said referrer computer or said referee computer.

35. The method of claim 1 further comprising causing a computer to be identified as being associated with said referrer or said referee, in response to a respective referrer or referee key associated with said referrer or referee respectively, received from said computer.

36. The method of claim 1 further comprising linking said identifications with a display interface operable to cause information units in a corresponding collection to be displayed.

37. A signal encoded with computer-readable codes for directing a processor circuit to perform the method recited in claim 1.

38. A computer-readable medium comprising codes for directing a processor circuit to perform the method recited in claim 1.

39. A computer-generated user interface soliciting responses from a user that are provided to a computer having a memory with computer-executable codes operable to cause said computer to perform the method of claim 1, in response to said responses.

40. An apparatus to facilitate management of referrals from a referrer to a referee, the apparatus comprising:
storing means, responsive to a first set of signals received from a referrer computer, for storing, in a database, information pertaining to a referral from said referrer to said referee, said information being stored as a collection of linked information units, said information units including a referrer identifier identifying said referrer as originator of said information and a referee identifier identifying said referee as intended recipient of said information, said collection representing said referral and being accessible by said referrer computer and a referee computer;
collection identification means, responsive to a second set of signals received from one of said referrer and referee computers, for identifying, in said database, collections of information units that satisfy a criterion, and for causing identifications to be displayed at said one of said referrer and referee computers, said identifications corresponding to respective collections of information units satisfying said criterion;
information display means, responsive to a third set of signals received from said one of said referrer and referee computers, for causing at least one information unit in a collection corresponding to a displayed identification, to be displayed at said one of said referrer and referee computers; and
information modification means, responsive to a fourth set of signals received from said one of said referrer and referee computers, for causing at least one information unit in said collection corresponding to a displayed identification, to be modified.

41. An apparatus to facilitate management of referrals from a referrer to a referee, the apparatus comprising:
a database interface operable to control a database, said database interface being operable to cause the database to store information from a referrer computer, said information pertaining to a referral from said referrer to said referee, said information being stored as a collection of linked information units, said information units including a referrer identifier identifying said referrer computer as originator of said information and a referee identifier identifying a referee computer as intended recipient of said information, said collection representing said referral;
a filter operable to cause said database interface to identify, in said database, collections of information units that satisfy a criterion, and to cause identifications to be displayed at one of said referrer and referee computers, said identifications corresponding to respective collections of information units satisfying said criterion; and
a client interface cooperating with said database interface and filter and operable to communicate with and be controlled from said referrer and referee computers, said client interface comprising:
a referral creation facility operable to facilitate causing said database interface to store said information as said collection in response to signals received from said referrer computer;
an information display facility operable to facilitating viewing, from said one of said referrer and referee computers, of at least one information unit in a collection identified by said filter; and
an information modification facility operable to facilitate causing a modification, from said one of said referrer and referee computers, of at least one information unit in a collection identified by said filter;
wherein said filter is operable to identify said collection when said collection satisfies said criterion and to cause an identification corresponding to said collection to be displayed at said one of said referrer and referee computers.

42. The apparatus of claim 41 wherein said database interface, said filter and said client interface are implemented by a processor circuit.

43. The apparatus of claim 42 wherein said processor circuit includes a processor and memory in communication with said processor, said memory being encoded with codes for directing said processor to effect said database interface, said filter and said client interface.

44. The apparatus of claim 43 wherein said codes include codes for directing said processor to cause a referral status flag to be stored in an information unit of said collection and to set said referral status flag to a set to a first value to indicate that the collection has not yet been viewed by the referee.

45. The apparatus of claim 44 wherein said codes include codes for directing said processor to cause said referral status flag to be set to a second value if at least one information unit of said collection has been displayed at said referee computer.

46. The apparatus of claim 43 wherein said codes include codes for directing said processor to cause, in said database, to identify said collections of information units that satisfy said criterion.

47. The apparatus of claim 46 wherein said codes include codes for directing said processor to cause said database to identify collections having a referral status flag satisfying a referral status criterion.

48. The apparatus of claim 46 wherein said codes comprise codes for directing said processor to cause said database to identify collections including at least one of said referrer identifier and said referee identifier.

49. The apparatus of claim 41 wherein said client interface is further operable to cooperate with said database interface to:
(a) facilitate uploading a file, into said database, from one of said referrer and referee computers in response to upload signals received therefrom; and
(b) facilitate downloading said file, from said database, to one of said referrer and referee computers in response to download signals received therefrom.

50. The apparatus of claim 43 wherein said codes include codes for directing said processor to cause said database to store a modification flag in an information unit of said collection and to cause said database to set said modification flag to a first value to indicate that the collection has not yet been modified.

51. The apparatus of claim 50, wherein said codes include:
codes for directing said processor to cause said database to cause said modification flag to be set to a second value when said information modification facility is controlled, from said one of said referrer and referee computers, to cause a modification to said collection identified by said filter; and
codes for directing said processor to cause the database to cause modification flag to be set a third value when said information display facility is controlled, from the other of said referrer and referee computers, to cause display of said collection identified by said filter.

52. The apparatus of claim 50 wherein said codes include codes for directing said processor to cause the database to store a value in said modification flag, said value representing a modification command received by said information modification facility from said one of said referrer and referee computers.

53. The apparatus of claim 52 wherein said codes comprise codes for directing said processor to cause the database to identify collections having a modification flag satisfying a modification criterion so that identifications corresponding to collections having information units that have been modified in accordance with said modification criterion, are displayed.

54. The apparatus of claim 52 wherein said codes include codes for directing said processor to cause a representation of said modification flag to be presented at at least one of said referrer and said referee computers.

55. The apparatus of claim 41 wherein said information display facility cooperates with said filter to cause labels respectively associated with said collections satisfying said criterion to be displayed at said one of said referrer and referee computers using a first set of display parameters.

56. The apparatus of claim 55 wherein said information display facility cooperates with said filter to cause labels associated with collections satisfying an additional selection criterion to be displayed at said one of said referrer and referee computers using a second set of display parameters in order to distinguish labels associated with collections which satisfy said additional selection criterion from labels associated with collections that do not.

57. The apparatus of claim 41 wherein said collection includes at least one of a client name or identifier, a client date of birth, a need, an urgency status associated with said need, a referrer name, and a referee name.

58. The apparatus of claim 41 wherein said referral creation facility is operable to produce a class identifier classifying said referral into a pre-defined classification in response to receiving said information, said referral creation facility being operable to cause said database interface to store said class identifier in information units associated with said collection.

59. The apparatus of claim 41 wherein said client interface is operable to cause at least one question to be presented to an operator of said referrer computer, to receive a response to said at least one question, and to cause said database interface to store said response.

60. The apparatus of claim 55 wherein said client interface is operable to cause a notification to be transmitted to said referrer computer when said response to said at least one question does not satisfy a validation criterion.

61. The apparatus of claim 41 wherein said filter causes identifications to be displayed in an order dependent upon at least one information unit in each collection corresponding to a displayed identification.

62. The apparatus of claim 41 wherein said database interface is operable to cause the database to maintain an event log for each collection and wherein said client interface is operable to cause said database interface to update said event log to cause an entry to be added to said event log in response to occurrence of an event involving said information modification facility being controlled from one of said referrer and referee computers to cause a modification to at least one information unit of said collection, wherein said entry includes at least one of a chronological order indicator, an identification of said event, and an identification of said one of said referrer and referee computers from which said modification was caused.

63. The apparatus of claim 62 wherein said information display facility is operable to be controlled from said one of said referrer and referee computers to cause display of said event log thereat.

64. The apparatus of claim 52 wherein said information modification facility responds to receiving said modification command from one of said referrer and referee computers by facilitating sending a message therefrom to the other of said referrer and referee computers.

65. The apparatus of claim 41 wherein said client interface is operable to cause information units from said database and computer-readable codes, to be transmitted to one of said referrer and referee computers, said computer-readable codes being operable to cause a processor circuit at said one of said referrer and referee computers,
(i) to cause at least some of said transmitted information to be displayed at said one of said referrer and referee computers; and
(ii) to facilitate generation, in response to user input at said one of said referrer and referee computers, of communication signals for transmission from said one of said referrer and referee computers to said client interface.

66. The apparatus of claim 41 wherein said client interface is operable to receive, from said one of said referrer and referee computers, a selection signal indicating selection of said collection identified by said filter, and to cause said information display facility to cause an information unit of said collection identified by said filter to be displayed at said one of said referrer and referee computers in response thereto.

67. The apparatus of claim 41 wherein said client interface further comprises an authentication facility operable to identify a computer from which signals are received as being associated with a user, in response to receiving from said computer a user key associated with a user identifier identifying said user.

68. The apparatus of claim 67 wherein said client interface is further operable to establish said criterion based on said user identifier.

69. The apparatus of claim 41 wherein said client interface is further operable to cause said filter to use, as said criterion, a predefined criterion selected from a set of predefined criteria, in response to a selection signal received from said computer, indicating said predefined criterion.

70. A data structure facilitating the communication of information pertaining to a referral from a referrer to a referee, the structure comprising:
a collection of linked information units pertaining to the referral, at least some of said information units of said collection being operable to be modified, said information units of said collection including:
a referrer identifier identifying a referrer computer as being originator of said collection, said referrer computer being associated with said referrer;
a referee identifier identifying a referee computer as an intended recipient of said collection, said referee computer being associated with said referee; and
a modification flag operable to indicate that a modification was made, from one of said referrer and referee computers, to at least one information unit of said collection.

71. A computer-readable medium encoded with the data structure of claim 70.

72. The data structure of claim 70 wherein said information units of said collection further include an event log operable to store an entry indicating occurrence of an event.

73. The data structure of claim 70 wherein said information units of said collection further include a referral status field operable to indicate a referral status comprising at least one of:
an unread status signifying that said collection has not been viewed from said referee computer;
an appointment set status signifying that an appointment has been set for the referral represented by said collection;
a cancelled status signifying that the referral represented by said collection has been cancelled; and
a completed status signifying that the referral represented by said collection has been completed by said referee.

74. The data structure of claim 70 wherein said information units of said collection further include at least one of a client name or identifier, a client date of birth, a need in respect of which the referral is made, an urgency status associated with said need, a referrer name, and a referee name.

75. The data structure of claim 70 wherein said information units of said collection further include at least one of:
a wait list priority field indicating a priority of the referral represented by said collection in a waitlist of said referee;
a wait list status field indicating a status of the referral in said waitlist; and
a waitlist reason field indicating a reason for placing the referral on said waitlist.

76. The data structure of claim 70 wherein said information units of said collection further include at least one of a referral date sent field, a referral type field, a referral identifier field, a notes field, a client contacted field indicating whether said client was contacted about the referral, a certainty flag for indicating a level of certainty regarding a diagnosis, a referral status field, an appointment time field, a referral reason field, an appointment cancellation reason field, a carbon copy field, a payer field, an attached files status field, and an archived status field.
